(19) United States
(12) Patent Application Publication
(10) Pub. No.: US 2026/0302095 A1
(43) Pub. Date: Oct. 1, 2026

(54) Ultracapacitor for Use at Low and High Temperatures

(71) Applicant: KYOCERA AVX Components Corporation, Fountain Inn, SC (US)

(72) Inventors: Xiaorong Liu, Simpsonville, SC (US); Marianne Berolini, Greer, SC (US); Jonathan Robert Knopsnyder, Fountain Inn, SC (US); Michael Maich, Simpsonville, SC (US); Bryan Caoile, Simpsonville, SC (US); Christophe Marrot, Saint Apollinaire (FR)

(21) Appl. No.: 19/565,648

(22) Filed: Mar. 13, 2026

Related U.S. Application Data
(60) Provisional application No. 63/780,604, filed on Mar. 31, 2025.

(51) Int. Cl. H01G 11/60; H01G 11/24; H01G 11/26; H01G 11/62

(52) U.S. Cl. CPC H01G 11/60; H01G 11/24; H01G 11/26; H01G 11/62

(57) ABSTRACT

An ultracapacitor that comprises a first electrode, a second electrode, a separator, an electrolyte system, and a housing is provided. The first electrode comprises a first current collector electrically coupled to a first carbonaceous coating and the second electrode comprises a second current collector electrically coupled to a second carbonaceous coating. The separator is positioned between the first electrode and the second electrode. The electrolyte system is in ionic contact with the first electrode and the second electrode and further comprises a sulfur-containing compound having a boiling point of about 200° C. or greater, a nonaqueous solvent having a boiling point of about 200° C. or less, and an ionic liquid comprising a cationic species and a counterion dissolved in the nonaqueous solvent. The housing retains the first electrode, the second electrode, the separator, and the electrolyte system. The first carbonaceous coating has a first thickness, the second carbonaceous coating has a second thickness, and the ratio of the first thickness to the second thickness if from about 1.0 to about 2.5.

### RELATED APPLICATION

The present application is based upon and claims priority to U.S. Provisional Patent Application Ser. No. 63/780,604, having a filing date of Mar. 31, 2025, which is incorporated herein by reference.

### BACKGROUND OF THE INVENTION

Electrochemical energy storage cells are widely used to provide power to electronic, electromechanical, electrochemical, and other useful devices. An electric double layer capacitor (e.g. “ultracapacitor”), for instance, generally employs a pair of polarizable electrodes that contain carbon impregnated with a liquid electrolyte and a separator positioned between the electrodes. Due to the effective surface area of the particles and the small spacing between the electrodes, large capacitance values may be achieved. However, many conventional ultracapacitors include electrolyte systems that may only allow operation up to certain temperatures.

For instance, some electrolyte systems are tailored for low temperature performance but may not allow for the resulting ultracapacitor to perform well at a high temperature range. Conversely, other electrolyte systems are tailored for high temperature performance but may not allow for the resulting ultracapacitor to perform well at a low temperature range. As a result, utilization of such ultracapacitors may be limited to only their narrow temperature range, as operation outside of the low or high temperature range may be detrimental to the effectiveness and lifespan of the ultracapacitor.

As such, a need currently exists for an improved electrolyte system and a corresponding ultracapacitor including the same that can function at both low and high temperature ranges.

### SUMMARY OF THE INVENTION

In accordance with one embodiment of the present invention, an ultracapacitor is disclosed that comprises a first electrode comprising a first current collector electrically coupled to a first carbonaceous coating and a second electrode comprising a second current collector electrically coupled to a second carbonaceous coating, wherein the first carbonaceous coating has a first thickness, the second carbonaceous coating has a second thickness, and the ratio of the first thickness to the second thickness is from about 1.0 to about 2.5. The ultracapacitor also comprises a separator positioned between the first electrode and the second electrode, and an electrolyte system in ionic contact with the first electrode and the second electrode. The electrolyte system comprises a sulfur-containing compound having a boiling point of about 200° C. or greater, a nonaqueous solvent having a boiling point of about 200° C. or less, and an ionic liquid comprising a cationic species and a counterion dissolved in the nonaqueous solvent. The ultracapacitor further comprises a housing within which the first electrode, the second electrode, the separator, and the electrolyte system are retained.

In accordance with another embodiment of the present invention, an electrolyte system is disclosed. The electrolyte system comprises a sulfur-containing compound having a boiling point of about 200° C. or greater, wherein the sulfur-containing compound comprises a first sulfur-containing compound and a second sulfur-containing compound. The electrolyte system also comprises a nonaqueous solvent having a boiling point of about 200° C. or less, and an ionic liquid comprising a cationic species and a counterion dissolved in the nonaqueous solvent. The first sulfur-containing compound is present in an amount of from about 30 wt. % to about 50 wt. %, the second sulfur-containing compound is present in an amount of from about 1 wt. % to about 10 wt. %, the ionic liquid is present in an amount of from about 10 wt. % to about 55 wt. %, and the nonaqueous solvent is present in an amount of about 10 wt. % to about 30 wt. % based on the weight of the electrolyte system.

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figure in which:

FIG. 1A and FIG. 1B graphically illustrate the results of Example 1;

FIG. 2A and FIG. 2B graphically illustrate the results of Example 2;

FIG. 3A and FIG. 3B graphically illustrate the results of Example 3;

FIG. 4A and FIG. 4B graphically illustrate the results of Example 4;

FIG. 5A and FIG. 5B graphically illustrate the results of Example 5; and

FIG. 6A and FIG. 6B graphically illustrate the results of Example 6.

Repeat use of reference characters in the present specification and drawing is intended to represent same or analogous features or elements of the invention.

### DETAILED DESCRIPTION OF REPRESENTATIVE EMBODIMENTS

It is to be understood by one of ordinary skill in the art that the present discussion is a description of exemplary embodiments only and is not intended as limiting the broader aspects of the present invention, which broader aspects are embodied in the exemplary construction.

Generally speaking, the present invention is directed to an ultracapacitor including a first electrode, a second electrode, a separator, an electrolyte system, and a housing. The first electrode includes a first current collector electrically coupled to a first carbonaceous coating, the second electrode includes a second current collector electrically coupled to a second carbonaceous coating, and the separator is positioned between the first electrode and the second electrode. The electrolyte systemd in ionic contact with the first electrode and the second electrode, wherein the electrolyte system includes a sulfur-containing compound having a boiling point of about 200° C. or greater, a nonaqueous solvent having a boiling point of about 200° C. or less, and an ionic liquid comprising a cationic species and a counterion dissolved in the nonaqueous solvent. The housing retains the first electrode, the second electrode, the separator, and the electrolyte system. Notably, the first carbonaceous coating has a first thickness, the second carbonaceous coating has a second thickness, and the ratio of the first thickness to the second thickness if from about 1.0 to about 2.5. The ultracapacitor may comprise a variety of structural configurations, including but not limited to those disclosed in U.S. Pat. No. 10,475,595 B2, the entire contents of which are hereby incorporated by reference.

Without intending to be limited by theory, the present inventors have discovered that by providing an electrolyte system as disclosed herein, an ultracapacitor having certain desired properties may be obtained. For instance, such properties may be realized over a wide operating temperature range, such that the ultracapacitor may demonstrate stability at both lower and higher temperatures. For instance, in certain embodiments, the ultracapacitor of the present disclosure may have an operating temperature of about −60° C. or greater, such as about −50° C. or greater, such as about −40° C. or greater, such as about −30° C. or greater, such as about −20° C. or greater, such as about −10° C. or greater, such as about 0° C. or greater, and generally less than about 150° C. or less, such as about 140° C. or less, such as about 130° C. or less, such as about 125° C. or less, such as about 120° C. or less, such as about 115° C. or less, such as about 110° C. or less, such as about 105° C. or less, such as about 100° C. or less, such as about 90° C. or less, such as about 85° C. or less, such as about 75° C. or less. Thus, the ultracapacitor may not only maintain enhanced electrochemical capabilities at lower end operating temperatures, such as about −40° C., but also can demonstrate stability at higher end operating temperatures, such as about 85° C. to about 125° C. In preferred embodiments, the ultracapacitor has an operating temperature of about −60° C. to about 150° C., such as about −40° C. to about 125° C.

While the present disclosure is generally directed to an ultracapacitor, in one embodiment, it may also be directed to an electrolyte system. As described above, the electrolyte system is retained within the housing and is in ionic contact with the first electrode and the second electrode. The electrolyte system includes a sulfur-containing compound having a boiling point of about 200° C. or greater, a nonaqueous solvent having a boiling point of about 200° C. or less, and an ionic liquid comprising a cationic species and a counterion dissolved in the nonaqueous solvent.

In certain embodiments, the sulfur-containing compound has a boiling point of about 215° C. to about 325° C. The solvent may include a first sulfur-containing compound and a second sulfur-containing compound. In some embodiments, the solvent may consist of or consist essentially of the first sulfur-containing compound and the second sulfur-containing compound. In other embodiments, the solvent may include a third sulfur-containing compound. For instance, the sulfur-containing compound may include a sulfolane, a sulfone, a sulfoxide, a sulfide, or a sulfite. In one embodiment, the sulfur-containing compound may include a sulfolane, a sulfone, or a sulfoxide. In a further embodiment, the sulfur-containing compound may include a sulfolane or a sulfone.

In some embodiments, the first sulfur-containing compound has a boiling point of about 250° C. or greater, such as about 260° C. or greater, such as about 270° C. or greater, such as about 275° C. or greater, such as about 280° C. or greater, such as about 285° C. or greater, and generally less than about 320° C., such as about 300° C. or less, such as about 295° C. or less, such as about 290° C. or less. Thus, in certain embodiments, the first sulfur-containing compound has a boiling point of about 270° C. to about 300° C., such as about 280° C. to about 290° C., such as about 285° C. The first sulfur-containing compound may be present in the electrolyte system in an amount of about 20 wt. % or greater, such as about 30 wt. % or greater, such as about 35 wt. % or greater, such as about 40 wt. % or greater, such as about 42.5 wt. % or greater, and generally less than about 60 wt. %, such as less than about 55 wt. %, such as less than about 50 wt. %, such as less than about 47.5 wt. % based on the weight of the electrolyte system. In some embodiments, the first sulfur-containing compound is present in an amount from about 30 wt. % to about 50 wt. %, such as about 40 wt. % to about 45 wt. %, such as 44 wt. % based on the weight of the electrolyte system.

In one embodiment, the first sulfur-containing compound comprises a sulfolane. In general, a sulfolane may have the following general structure:

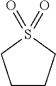

In another embodiment, the first sulfur-containing compound includes a sulfolane derivative. The sulfolane derivatives may include compounds wherein one or more of the hydrogen atoms is replaced by an organic radical, which may contain a polar grouping and more specifically may contain oxygen, nitrogen, sulfur and/or halide atoms. Sulfolane derivatives containing oxygen include hydroxy sulfolanes, sulfolanyl-ethers and -esters; sulfolane derivatives containing nitrogen include sulfolanyl-amines, -nitriles and nitro sulfolanes; sulfolane derivatives containing sulfur include sulfolanyl sulfides, -sulfoxides and -sulfones.

Some specific sulfolane derivatives include, but are not limited to, hydrocarbon-substituted sulfolanes such as alkyl sulfolanes preferably containing not more than about 10 carbon atoms; hydroxy sulfolanes such as 3-sulfolanol, 2-sulfolanol, 3-methyl-4-sulfolanol, 3-4-sulfolanediol; sulfolanyl ethers such as methyl-3-sulfolanyl ether, propyl-3-sulfolanyl ether, allyl-3-sulfolanyl ether, butyl-3-sulfolanyl ether, crotyl-3-sulfolanyl ether, isobutyl-3-sulfolanyl ether, methallyl-3-sulfolanyl ether, methyl vinyl carbinyl-3-sulfolanyl ether, amyl-3-sulfolanyl ether, hexyl-3-sulfolanyl ether, octyl-3-sulfolanyl ether, nonyl-3-sulfolanyl ether, glycerol alpha-gamma-diallyl-beta-3-sulfolanyl ether, tetrahydrofurfuryl-3-sulfolanyl ether, 3,3,5-tetramethyl-cyclohexyl-3-sulfolanyl ether, m-cresyl-3-sulfolanyl ethers, corresponding 2-sulfolanyl ethers, disulfolanyl ethers; sulfolanyl esters such as 3-sulfolanyl actetate, 3-sulfolanylcaproate, sulfolanyllaurate, sulfolanylpalmitate, sulfolanylstearate, sulfolanyloleate, sulfolanylpropionate, sulfolanylbutyrate; N-sulfolanes such as 3-sulfolanylamine, N-methyl-3-sulfolanylamine, N-ethyl-3-sulfolanylamine, N—N-dimethyl-3-sulfolanylamine, N-allyl-3-sulfolanylamine, N-butyl-3-sulfolanylamine, N-octyl-3-sulfolanylamine; sulfolanyl sulfides such as ethyl-3tertiary butyl-3-sulfolanyl sulfide, isobutyl-3-sulfolanyl sulfide, methallyl-3-sulfolanyl sulfide, di-3-sulfolanyl sulfide; sulfolanyl sulfones such as methyl-3-sulfolanyl sulfone, ethyl-3-sulfolanyl sulfone, propyl-3-sulfolanyl sulfone, amyl-3-sulfolanyl sulfone; and sulfolanyl halides such as 3-chloro-sulfolanyl halide, 3-4-dichloro-sulfolanyl halide, 3-chloro-4-methyl sulfolanes.

In one embodiment, the sulfolane may simply be sulfolane having the aforementioned structure. In this regard, the sulfolane may not be a sulfolane derivative.

In some embodiments, the second sulfur-containing compound has a boiling point of about 200° C. or greater, such as about 210° C. or greater, such as about 220° C. or greater, such as about 230° C. or greater, such as about 235° C. or greater, and generally less than about 260° C., such as less than about 250° C., such as less than about 240° C. In certain embodiments, the second sulfur-containing compound has a boiling point of about 220° C. to about 250° C., such as about 238° C. The second sulfur-containing compound may be present in the electrolyte system in an amount of about 0.05 wt. % or greater, such as about 1 wt. % or greater, such as about 2 wt. % or greater, such as about 3 wt. % or greater, such as about 4 wt. % or greater, such as about 5 wt. % or greater, and generally less than about 15 wt. %, such as less than about 12.5 wt. %, such as less than about 10 wt. %, such as less than about 7.5 wt. % based on the weight of the electrolyte system. Thus, in certain embodiments, the second sulfur-containing compound is present in an amount of from about 1 wt. % to about 10 wt. %, such as about 5 wt. %, based on the weight of the electrolyte system.

In one embodiment, the second sulfur-containing compound comprises a sulfone. For instance, the sulfone may have the following general structure:

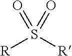

wherein R and R′ are an optionally substituted hydrocarbyl moiety. Generally, “hydrocarbyl” means a hydrocarbon substituent including aliphatic (straight-chain and branched-chain) and cyclic, such as alicyclic, and aromatic groups. For instance, the hydrocarbyl moiety may be an alkyl or an aryl.

In one embodiment, the hydrocarbyl moiety may be unsubstituted. In another embodiment, the hydrocarbyl moiety may be substituted. The moiety may include from 1 to 5 and, in some embodiments, 1 to 3 or 1 to 2 substituents. The substitution may include, but is not limited to, alkoxy, alkyl, amino, aryl, carboxyl, carboxyl ester, cyano, cycloalkyl, halo, hydroxy, nitro, oxo, sulfate, sulfonyl, thiol, etc. However, it should be understood that other substituent groups may also be utilized for substitutions. Furthermore, it should be understood that such substituent groups themselves may also include further substitutions. In one embodiment, the hydrocarbyl moiety may be an alkyl substituted with an aryl. Similarly, the hydrocarbyl moiety may be an aryl substituted with an alkyl.

In one embodiment, the sulfone may be referred to as an alkyl sulfone or a dialkyl sulfone. For instance, R and R′ may each independently be an alkyl group. The alkyl group may be a straight chain, branched chain, or cyclic monovalent saturated aliphatic hydrocarbyl group. The alkyl may have from 1 to 10 carbon atoms, such as from 1 to 6 carbon atoms, such as from 1 to 5 carbon atoms, such as from 1 to 4 carbon atoms, such as from 1 to 3 carbon atoms, such as from 1 to 2 carbon atoms, such as 1 carbon atom. The alkyl in one embodiment may be methyl.

In one embodiment, both R and R′ may be different. In another embodiment, both R and R′ may be the same. For example, they may both be alkyl. Even further, they may both be methyl.

The sulfone may include, but is not limited to, dimethyl sulfone, ethyl methyl sulfone, dipropyl sulfone, ethyl propyl sulfone, diethyl sulfone, dibutyl sulfone, propyl methyl sulfone, diisopropyl sulfone, isopropyl methyl sulfone, isopropyl ethyl sulfone, and combinations thereof. In this regard, in one embodiment, the sulfone may be dimethyl sulfone.

In another embodiment, the sulfur-containing compound may be a sulfoxide. In general, a sulfoxide may have the following general structure:

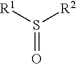

wherein R1 and R2 are an optionally substituted hydrocarbyl moiety. Generally, “hydrocarbyl” means a hydrocarbon substituent including aliphatic (straight-chain and branched-chain) and cyclic, such as alicyclic, and aromatic groups. For instance, the hydrocarbyl moiety may be an alkyl or an aryl.

In one embodiment, the hydrocarbyl moiety may be unsubstituted. In another embodiment, the hydrocarbyl moiety may be substituted. The moiety may include from 1 to 5 and, in some embodiments, 1 to 3 or 1 to 2 substituents. The substitution may include, but is not limited to, alkoxy, alkyl, amino, aryl, carboxyl, carboxyl ester, cyano, cycloalkyl, halo, hydroxy, nitro, oxo, sulfate, sulfonyl, thiol, etc. However, it should be understood that other substituent groups may also be utilized for substitutions. Furthermore, it should be understood that such substituent groups themselves may also include further substitutions. In one embodiment, the hydrocarbyl moiety may be an alkyl substituted with an aryl. Similarly, the hydrocarbyl moiety may be an aryl substituted with an alkyl.

In one embodiment, the sulfoxide may be referred to as an alkyl sulfoxide or a dialkyl sulfoxide. For instance, R¹ and R² may each independently be an alkyl group. The alkyl group may be a straight chain, branched chain, or cyclic monovalent saturated aliphatic hydrocarbyl group. The alkyl may have from 1 to 10 carbon atoms, such as from 1 to 6 carbon atoms, such as from 1 to 5 carbon atoms, such as from 1 to 4 carbon atoms, such as from 1 to 3 carbon atoms, such as from 1 to 2 carbon atoms, such as 1 carbon atom. The alkyl in one embodiment may be methyl.

In one embodiment, both R¹ and R² may be different. In another embodiment, both R¹ and R² may be the same. For example, they may both be alkyl. Even further, they may both be methyl. In this regard, such sulfoxide may be a dimethyl sulfoxide.

In one embodiment, at least one sulfur-containing compound may be a sulfide. In general, a sulfide is an inorganic anion of sulfur with the formula S²⁻ or a compound containing one or more S²⁻ ions.

The sulfide may include, but is not limited to, dimethyl sulfide, butyl sulfide, dibutyl sulfide, dipropyl sulfide, dioctyl sulfide, dibenzyl sulfide, diphenyl sulfide, ethylene sulfide, ethyl sulfide, methyl phenyl sulfide, ethyl vinyl sulfide, and combinations thereof.

In one embodiment, at least one sulfur-containing compound may be a sulfite. In general, a sulfite is a compound containing a sulfite ion SO₃²⁻.

The sulfite may include, but is not limited to, ethylene sulfite, 1,3-propylene sulfite, 1,2-propyleneglycol sulfite, dimethyl sulfite, vinyl ethylene sulfite, trimethylene sulfite, and combinations thereof.

Aside from the sulfur-containing compounds, the solvent may include other solvents generally known in the art. For instance, the solvent may further include, but is not limited to, cyclic carbonate solvents (e.g., ethylene carbonate, propylene carbonate, butylene carbonate, vinylene carbonate, etc.), open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, benzonitrile etc.), amides (e.g., N,N-dimethylformamide, N,N-diethylacetamide, N-methylpyrrolidinone), alkanes (e.g., nitromethane, nitroethane, etc.), and so forth.

For instance, in addition to the high boiling point sulfur-containing compound, the electrolyte system also includes a low-boiling point nonaqueous solvent having a boiling point of about 200° C. or less. In some embodiments, the nonaqueous solvent has a boiling point of generally less than about 200° C., such as less than about 150° C., such as less than about 100° C., such as less than about 90° C., such as less than about 85° C., and generally greater than about 50° C., such as greater than about 60° C., such as greater than about 70° C., such as greater than about 80° C. The nonaqueous solvent may also be present in an amount of about 5 wt. % or greater, such as about 10 wt. % or greater, such as about 15 wt. % or greater, such as about 17.5 wt. % or greater, and generally less than about 35 wt. % or less, such as about 30 wt. % or less, such as about 25 wt. % or less, such as about 22.5 wt. % or less, such as about 20 wt. % or less based on weight of the electrolyte system. Thus in certain embodiments, the nonaqueous solvent may be present in an amount from about 10 wt. % to about 30 wt. %, such as about 15 wt. % to about 20 wt. % based on the weight of the electrolyte system.

In certain embodiments, the nonaqueous solvent includes a nitrile compound, such as acetonitrile, glutaronitrile, adiponitrile, methoxyacetonitrile, 3-methoxypropionitrile, benzonitrile etc., amides (e.g., N,N-dimethylformamide, N,N-diethylacetamide, N-methylpyrrolidinone), alkanes (e.g., nitromethane, nitroethane, etc.), and so forth. In some embodiments, the low boiling point nonaqueous solvent is acetonitrile.

The electrolyte system also contains at least one ionic liquid, which may be dissolved in the solvent. In certain embodiments, the ionic liquid may be present in an amount of about 5 wt. % or greater, such as about 10 wt. % or greater, such as about 15 wt. % or greater, such as about 20 wt. % or greater, such as about 25 wt. % or greater, such as about 30 wt. % or greater, and generally less than about 60 wt. %, such as less than about 55 wt. %, such as less than about 50 wt. %, such as less than about 45 wt. %, such as less than about 40 wt. %, such as less than about 35 wt. % based on the weight of the electrolyte system. Thus, in some embodiments, the ionic liquid may be present in an amount of about 10 wt. % to about 55 wt. %, such as about 20 wt. % to about 35 wt. %, such as about 32 wt. % based on the weight of the electrolyte system.

While the concentration of the ionic liquid can vary, it is typically desired that the ionic liquid is present at a relatively high concentration. For example, the ionic liquid may be present in an amount of about 0.5 moles per liter (M) of the electrolyte or more, such as about 0.8 M or more, such as about 1.0 M or more, such as about 1.2 M or more, such as about 1.3 M or more, such as about 1.5 M or more. The ionic liquid may be present in an amount of about 3.0 M or less, such as about 2.5 M or less, such as about 2.0 M or less, such as about 1.8 M or less, such as about 1.5 M or less, such as about 1.4 M or less, such as about 1.3 M or less.

The ionic liquid is generally a salt having a relatively low melting temperature, such as about 400° C. or less, in some embodiments about 350° C. or less, in some embodiments from about 1° C. to about 100° C., and in some embodiments, from about 5° C. to about 50° C.

The salt contains a cationic species and counterion. The cationic species contains a compound having at least one heteroatom (e.g., nitrogen or phosphorous) as a “cationic center.” In this regard, the ionic liquid may include an organoquaternary ammonium compound, organoquaternary phosphonium compound, or a mixture thereof. Examples of such heteroatomic compounds include, for instance, unsubstituted or substituted organoquaternary ammonium compounds, such as ammonium (e.g., trimethylammonium, tetraethylammonium, etc.), pyridinium, pyridazinium, pyramidinium, pyrazinium, imidazolium, pyrazolium, oxazolium, triazolium, thiazolium, quinolinium, piperidinium, pyrrolidinium, quaternary ammonium spiro compounds in which two or more rings are connected together by a spiro atom (e.g., carbon, heteroatom, etc.), quaternary ammonium fused ring structures (e.g., quinolinium, isoquinolinium, etc.), and so forth. the organoquaternary ammonium (or phosphonium) compounds may be a compound having only an aliphatic chain, an alicyclic compound having an aliphatic chain and an aliphatic ring, and a spiro compound having only aliphatic rings. It should be noted that the spiro compound is a compound having a structure in which two rings share one atom of a tetrahedron structure.

In one particular embodiment, for example, the cationic species may be an N-spirobicyclic compound, such as symmetrical or asymmetrical N-spirobicyclic compounds having cyclic rings. One example of such a compound has the following structure:

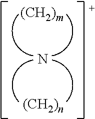

wherein m and n are independently a number from 3 to 7, and in some embodiments, from 4 to 5 (e.g., pyrrolidinium or piperidinium).

Particularly suitable cations have a median ionic radius size of greater than about 0.10 nanometers, such as greater than about 0.11 nanometers, such as greater than about 0.12 nanometers, such as greater than about 0.13 nanometers, such as greater than about 0.14 nanometers, such as greater than 0.15 nanometers, such as greater than 0.16 nanometers. In other embodiments particularly suitable cations have a median ionic radius size of less than about 1.0 nanometers, such as less than about 0.5 nanometers, such as less than about 0.3 nanometers, such as less than about 0.2 nanometers, such as less than about 0.19 nanometers, such as less than about 0.18 nanometers, such as less than about 0.17 nanometers. In certain embodiments, the ionic radius may be the solvated ionic radius if the ions are in liquid solutions, such that the median ionic radius takes into account the radius of the ion and the solvation shell. In preferred embodiments, suitable cations include tetraethylammonium, triethylmethylammonium, spiro-(1,1′)-bipyrrolidinium, N,N′-dimethylpiperazine, and 1,1-dimethylpyrrolidinium.

Suitable counterions for the cationic species may likewise include halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing. In some embodiments, the counterion that may construct the salt may be exemplified by PF6⁻, BF4⁻, N(CF₃SO₃)₂⁻, and C(CF₃SO₃)₃⁻.

Particularly suitable counterions have a median ionic radius size of greater than about 0.03 nanometers, such as greater than about 0.04 nanometers, such as greater than about 0.05 nanometers, such as greater than about 0.06 nanometers, such as greater than about 0.07 nanometers, such as greater than about 0.08 nanometers, such as greater than about 0.09 nanometers, such as greater than about 0.10 nanometers. In other embodiments, particularly suitable counterions have a median ionic radius size of less than about 1.0 nanometers, such as less than about 0.5 nanometers, such as less than about 0.2 nanometers, such as less than about 0.15 nanometers, such as less than about 0.14 nanometers, such as less than about 0.13 nanometers, and such as less than about 0.125 nanometers. In certain embodiments, the ionic radius may be the solvated ionic radius if the ions are in liquid solutions, such that the median ionic radius takes into account the radius of the ion and the solvation shell. In preferred embodiments, suitable counterions include tetrafluoroborate and bis(oxolato)borate.

Several examples of suitable ionic liquids may include, for instance, spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, tetraethylammonium hexafluorophosphate, 5-azoniaspiro[4.4]nonane tetrafluoroborate (spiro-(1,1′)-bipyrrolidinium: SBP-BF4), 6-azoniaspiro[5.5]undecane tetrafluoroborate, 3-azoniaspiro[2.6]nonane tetrafluoroborat, 1,1-dimethylpyrrolidinium tetrafluoroborate, etc. Further, examples of the quaternary phosphonium based ionic liquids include 5-phosphonylspiro[4.4]nonane tetrafluoroborate. In this regard, a particular suitable ionic liquid may include a tetrafluoroborate spiro quaternary compound, such as a tetrafluoroborate spiro quaternary ammonium and/or a tetrafluoroborate spiro quaternary phosphonium.

In one embodiment, the ionic liquid may include a cyclic compound. For instance, as indicated above, the ionic liquid may include a spiro compound. However, it should be understood that the ionic liquid may not include a spiro compound yet may include a cyclic compound (e.g., a pyrrolidinium, such as 1,1-dimethylpyrrolidinium tetrafluoroborate).

Suitable ionic liquid displays a ratio of the median ionic radius size of the cationic species to the median ionic radius size of the counterion of greater than about 1.0, such as greater than about 1.5, such as greater than about 2.0, such as greater than about 2.5, such as greater than about 3.0, such as greater than about 3.5, such as greater than about 4.0, such as greater than about 4.5, such as greater than about 5.0. In other embodiments, the ionic liquids display a ratio of the median ionic radius size of the cationic species to the median ionic radius of the counterion of less than about 10.0, such as less than about 9.0, such as less than about 8.0, such as less than about 7.0. In some embodiments, the ionic liquid displays a ratio of the median ionic radius size of the cationic species to the median ionic radius size of the counterion of greater than about 3.0, such as greater than about 3.5, such as greater than about 4.0, such as greater than about 5.0.

In some embodiments, suitable ionic liquid displays a ratio of the amount of cations to counterions present in the ionic liquid of about 10 or less, such as about 9 or less, such as about 8 or less, such as about 7 or less, such as about 6 or less, such as about 5 or less, and generally greater than about 0.05 or more, such as about 0.1 or more, such as about 0.5 or more, such as about 1 or more. Thus, in certain embodiments, the ionic liquid displays a ratio of the amount of cations to counterions present in the ionic liquid of about 1 to about 5.

In other embodiments, the electrolyte system includes a lithium metal salt. For instance, a non-limiting list of suitable lithium metal salts that can be utilized include LiCF₃SO₃, LiN(CF₃SO₂)₂, LiNO₃, LiF, LiPF₆, LiBF₄, LiI, LiBr, LiSCN, LiClO₄, LiAlCl₄, LiB(C₂O₄)₂, LiB(C₆H₅)₄, LiBF₂(C₂O₄), LiN(SO₂F)₂, LiPF₃(C₂F₅)₃, LiPF₄(CF₃)₂, LiPF₄(C₂O₄), LiPF₃(CF₃)₃, LiSO₃CF₃, LiAsF₆, and mixtures thereof. In one particular embodiment, the lithium metal salt may include LiF.

In one embodiment, the lithium metal salt may include one having a fluorine atom. For instance, the lithium metal salt may include a fluoride. In particular, the lithium metal salt may include lithium fluoride.

In some embodiments, the electrolyte system may be substantially free of a lithium metal salt.

Regardless of the number of solvents present within the electrolyte system, it should be understood that the total weight percentage of all of the solvents should be about 100 wt. % based on the combination of the solvents present within the electrolyte system.

As indicated above, the ultracapacitor further includes a first electrode and a second electrode. The first electrode comprises a first current collector electrically coupled to a first carbonaceous coating and the second electrode comprises a second current collector electrically coupled to a second carbonaceous coating. In some embodiments, the first and second electrodes may also contain binders.

In certain embodiments, however, the electrodes need not contain a substantial amount of binders conventionally employed in ultracapacitor electrodes. That is, binders may be present in an amount of about 60 parts or less, in some embodiments 40 parts or less, and in some embodiments, from about 1 to about 25 parts per 100 parts of carbon in the first and/or second carbonaceous coatings. Binders may, for example, constitute about 15 wt. % or less, in some embodiments about 10 wt. % or less, and in some embodiments, from about 0.5 wt. % to about 5 wt. % of the total weight of a carbonaceous coating.

Nevertheless, when employed, any of a variety of suitable binders can be used in the electrodes. For instance, in some embodiments, a water-insoluble organic binder, a water-soluble organic binder, or a combination thereof may be utilized in the electrodes. In some embodiments, a water-insoluble organic binder may be employed, such as a styrene-butadiene copolymer, a polyvinyl acetate homopolymer, a vinyl-acetate ethylene copolymer, a vinyl-acetate acrylic copolymer, an ethylene-vinyl chloride copolymer, an ethylene-vinyl chloride-vinyl acetate terpolymer, an acrylic polyvinyl chloride polymer, an acrylic polymer, a nitrile polymer, a fluoropolymer such as polytetrafluoroethylene or polyvinylidene fluoride, a polyolefins, or a combination thereof.

In other embodiments, a water-soluble organic binder may be employed, such as a polysaccharide and derivatives thereof. In one particular embodiment, the polysaccharide may be a nonionic cellulosic ether, such as an alkyl cellulose ether (e.g., a methyl cellulose and an ethyl cellulose); a hydroxyalkyl cellulose ether (e.g., a hydroxyethyl cellulose, a hydroxypropyl cellulose, a hydroxypropyl hydroxybutyl cellulose, a hydroxyethyl hydroxypropyl cellulose, a hydroxyethyl a hydroxybutyl cellulose, a hydroxyethyl hydroxypropyl hydroxybutyl cellulose, etc.); an alkyl hydroxyalkyl cellulose ether (e.g., a methyl hydroxyethyl cellulose, a methyl hydroxypropyl cellulose, an ethyl hydroxyethyl cellulose, an ethyl hydroxypropyl cellulose, a methyl ethyl hydroxyethyl cellulose and a methyl ethyl hydroxypropyl cellulose); a carboxyalkyl cellulose ether (e.g., a carboxymethyl cellulose); and so forth, as well as protonated salts of any of the foregoing, such as a sodium carboxymethyl cellulose and an ammonium carboxymethyl cellulose.

As discussed above, the ultracapacitor of the present invention contains first and second carbonaceous coatings that are electrically coupled to the first and second current collectors, respectively. While the first and second carbonaceous coatings may be formed from the same or different types of materials and may contain one or multiple layers, each of the carbonaceous coatings generally contains at least one layer that includes activated carbon particles, binders, and/or carbon black. In certain embodiments, for instance, the carbonaceous coating may be directly positioned over the current collector. Examples of suitable activated carbon particles used in the carbonaceous coatings may include, for instance, potassium hydroxide (KOH) activated carbon, water steam activated carbon, coconut shell-based activated carbon, petroleum coke-based activated carbon, pitch-based activated carbon, polyvinylidene chloride-based activated carbon, phenolic resin-based activated carbon, polyacrylonitrile-based activated carbon, and activated carbon from natural sources such as coal, charcoal or other natural organic sources. In some embodiments, the first and second carbonaceous coating comprise the same material. In other embodiments, the first and second carbonaceous coatings comprise different materials.

In certain embodiments, it may be desired to selectively control certain aspects of the activated carbon particles, such as their particle size distribution, surface area, and pore size distribution to help reduce ion mobility of the electrolyte system after being subjected to one or more charge-discharge cycles. Therefore, in certain embodiments, the first carbonaceous coating and the second carbonaceous coating may comprise the same material. Even when the first carbonaceous coating and the second carbonaceous coating comprise the same material(s), they may have different porosity profiles. However, in preferred embodiments, they may also have the same porosity or particle profiles.

For instance, in some embodiments, the first and/or second plurality of pores of the first and/or second carbonaceous coatings, respectively, have a pore volume with a median diameter size of less than about 2 nanometers in size (i.e., “micropores”) of about 50 vol. % or less, such as 45 vol. % or less, such as 40 vol. % or less, such as 35 vol. % or less, such as about 30 vol. % or less, such as 25 vol. % or less, such as 20 vol. % or less. In other embodiments, the pore volumes have a median diameter size of less than about 2 nanometers of about 0.1 vol. % or more, such as about 0.5 vol. % or more, such as about 1 vol. % or more, such as about 5 vol. % or more, such as about 10 vol. % or more, such as about 15 vol. % or more. In some embodiments, the first and/or second plurality of pores have a pore volume with a median diameter size of less than about 2 nanometers of from 0.1 vol. % to 15 vol. % of their respective pore volumes.

The amount of pores between about 2 nanometers and about 50 nanometers in size (i.e., “mesopores”) may likewise be from about 20 vol. % to about 100 vol. %, in some embodiments from about 25 vol. % to about 75 vol. %, and in some embodiments, from about 35 vol. % to about 65 vol. % of the first and second pore volumes. For instance, in some embodiments, the amount of pores between about 2 nanometers to about 50 nanometers in size may be about 20 vol. % or more, such as about 25 vol % or more, such as about 30 vol. % or more, such as about 35 vol. % or more, such as about 40 vol. % or more, such as about 50 vol. % or more, such as about 60 vol. % or more, such as about 70 vol. % or more. In other embodiments, the amount of pores between about 2 nanometers to about 50 nanometers in size may be about 100 vol. % or less, such as about 90 vol. % or less, such as about 80 vol. % or less, such as about 75 vol. % or less, such as about 70 vol. % or less, such as about 65 vol. % or less, such as about 60 vol. % or less, such as about 55 vol. % or less, such as about 50 vol. % or less, such as about 45 vol. % or less.

The amount of pores greater than about 50 nanometers in size (i.e., “macropores”) may be from about 10 vol. % to about 100 vol. %, in some embodiments from about 5 vol. % to about 75 vol. %, and in some embodiments, from about 10 vol. % to about 50 vol. % of the first and second pore volumes. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more, such as about 30 vol. % or more, such as about 40 vol. % or more, such as about 45 vol. % or more, such as about 50 vol. % or more, such as about 55 vol. % or more, such as about 60 vol. % or more. In other embodiments, the amount of pores greater than about 50 nanometers in size may be about 100 vol. % or less, such as about 90 vol. % or less, such as about 80 vol. % or less, such as about 70 vol. % or less, such as about 60 vol. % or less, such as about 50 vol. % or less, such as about 45 vol. % or less, such as about 40 vol. % or less, such as about 35 vol. % or less, such as about 30 vol. % or less.

The total pore volume of the first and/or second plurality of pores may be in the range of from about 0.2 cm³/g to about 2.0 cm³/g, and in some embodiments, from about 0.4 cm³/g to about 1.0 cm³/g. In other embodiments, the single point adsorption total pore volume of pores less than about 3,650 Å at about p/p°=1.0 in the second carbonaceous coating is about 0.770 m³/g or greater, such as about 0.780 m³/g or greater, such as about 0.790 m³/g or greater, and such as about 0.810 m³/g or less, such as about 0.800 m³/g or less. In certain embodiments, the single point adsorption total pore volume is about 0.786 m³/g.

The first and/or second carbonaceous coatings may comprise activated carbon particles with a BET surface area of about 1,300 m²/g or greater, such as about 1,350 m²/g or greater, such as about 1,360 m²/g or greater, such as about 1,370 m²/g or greater. In other embodiments, the first and/or second carbonaceous coating comprises activated carbon particles with a BET surface area of about 1,450 m²/g or less, such as about 1,425 m²/g or less, such as about 1,400 m²/g or less, such as about 1,380 m²/g or less. In preferred embodiments, the first and/or second carbonaceous coating comprises activated carbon particles with a BET surface area of about 1,360 m²/g to about 1,370 m²/g.

In certain embodiments, the first and/or second plurality of pores have a median pore diameter size and the ratio of the median pore diameter size of the first and second plurality of pores to the median ionic radius size of the counterion is from about 1.5 to about 10.0. For instance, the ratio of the median pore diameter size of the first and/or second plurality of pores to the median ionic radius size of the counterion is from about 1.5 or more, such as about 2.0 or more, such as about 2.5 or more, such as about 3.0 or more, such as about 3.5 or more, such as about 4.0 or more, In other embodiments, the ratio of the median pore diameter size of the first and/or second plurality of pores to the median ionic radius size of the counterion is from about 10 or less, such as about 9 or less, such as about 8 or less, such as about 7 or less, such as about 6 or less, such as about 5.0 or less. In certain embodiments, the ratio of the median pore diameter size of the first and second plurality of pores to the median ionic radius size of the counterion is from about 1.5 to about 5.0.

In other embodiments, the first and/or second plurality of pores of the first and/or second carbonaceous coatings, respectively, have a total pore volume, the total pore volume comprising about 50 vol. % or more of pores having a median pore diameter size of about 2 nanometers (i.e., “micropores”) or less, such as about 55 vol. % or more of pores having a median pore diameter size of about 2 nanometers or less, such as about 60 vol. % or more of pores having a median pore diameter size of about 2 nanometers or less, such as about 65 vol. % or more of pores having a median pore diameter size of about 2 nanometers or less, such as about 70 vol. % or more of pores having a median pore diameter size of about 2 nanometers or less, such as about 75 vol. % or more of pores having a median pore diameter size of about 2 nanometers or less. In other embodiments, the total pore volume comprises about 100 vol. % or less of pores having a median pore diameter size of about 2 nanometers or less, such as about 95 vol. % or less of pores having a median pore diameter size of about 2 nanometers or less, such as about 90 vol. % or less of pores having a median pore diameter size of about 2 nanometers or less, such as about 85 vol. % or less of pores having a median pore diameter size of about 2 nanometers or less.

The amount of pores between about 2 nanometers and about 50 nanometers in size (i.e., “mesopores”) may likewise be from about 20 vol. % to about 50 vol. %, in some embodiments from about 25 vol. % to about 45 vol. %, and in some embodiments, from about 35 vol. % to about 40 vol. % of the first pore volume. For instance, in some embodiments, the amount of pores between about 2 nanometers to about 50 nanometers in size may be about 5 vol. % or more, such as about 10 vol. % or more, such as about 15 vol. % or more, such as about 20 vol. % or more, such as about 25 vol % or more, such as about 30 vol. % or more, such as about 35 vol. % or more, such as about 40 vol. % or more. In other embodiments, the amount of pores between about 2 nanometers to about 50 nanometers in size may be about 60 vol. % or less, such as about 55 vol. % or less, such as about 50 vol. % or less, such as about 45 vol. % or less.

The amount of pores greater than about 50 nanometers in size (i.e., “macropores”) may be from about 1 vol. % to about 50 vol. %, in some embodiments from about 5 vol. % to about 40 vol. %, and in some embodiments, from about 10 vol. % to about 35 vol. % of the first pore volume. For instance, in some embodiments, the amount of pores greater than about 50 nanometers in size may be about 1 vol. % or more, such as about 5 vol. % or more, such as about 10 vol. % or more, such as about 15 vol. % or more, such as about 20 vol. % or more, such as about 25 vol. % or more. In other embodiments, the amount of pores greater than about 50 nanometers in size may be about 50 vol. % or less, such as about 45 vol. % or less, such as about 40 vol. % or less, such as about 35 vol. % or less, such as about 30 vol. % or less.

The total pore volume of the carbon particles in the first and/or second plurality of pores may be in the range of from about 0.2 cm³/g to about 2.0 cm³/g, and in some embodiments, from about 0.4 cm³/g to about 1.0 cm³/g. In other embodiments, the total pore volume of the carbon particles in the first plurality of pores is about 0.97 cm³/g. In certain embodiments, the single point adsorption total pore volume of pores less than about 3,650 Å at about p/p°=1.0 is about 0.800 m³/g or more, such as about 0.840 m³/g or more, such as about 0.880 m³/g or more, such as about 0.900 m³/g or more, and in some embodiments, such as about 0.950 m³/g or less, such as about 0.930 m³/g or less, such as about 0.920 m³/g or less.

The BET surface area of the activated carbon particles in the first and/or second carbonaceous coating may also range from about 900 m²/g to about 3,000 m²/g, in some embodiments from about 1,000 m²/g to about 2,500 m²/g, and in some embodiments, from about 1,100 m²/g to about 1,800 m²/g. In certain embodiments, the BET surface area of the activated carbon particles may be about 1,300 m²/g or greater, such as 1,400 m²/g, such as 1,500 m²/g or greater. In other embodiments, the BET surface area of the activated carbon particles may be about 1,750 m²/g or less, such as 1,700 m²/g or less, such as about 1,600 m²/g or less. In other embodiments, the activated carbon in the first and/or second carbonaceous coating has a BET surface area of about 1630 m²/g to about 1720 m²/g.

In certain embodiments, the first and/or second plurality of pores of the first and/or second carbonaceous coating, respectively, have a median pore diameter size, the counterion of the ionic liquid has a median ionic radius size, and the ultracapacitor demonstrates a ratio of the median pore diameter size of the first and/or second plurality of pores to the median ionic radius size of the counterion of from about 0.5 or greater, such as from about 0.6 or greater, such as from about 0.7 or greater, such as from about 0.8 or greater, such as from about 0.9 or greater, and such as from about 1.0 or greater. In other embodiments, the ratio of the median pore diameter size of the first plurality of pores to the median ionic radius size of the counterion is from about 1.5 or less, such as from about 1.4 or less, such as from about 1.3 or less, such as from about 1.2 or less, and such as from about 1.1 or less. In preferred embodiments, the ratio of the median pore diameter size of the first and/or second plurality of pores to the median ionic radius size of the counterion is about 0.95 to about 1.05. For instance, in certain embodiments, the ratio of the median pore diameter size of the first and/or second plurality of pores to the median ionic radius size of the counterion is about 0.95 or greater, such as about 0.96 or greater, such as about 0.97 or greater, such as about 0.98 or greater, such as about 0.99 or greater, such as about 1.0 or greater, In other embodiments, the ratio of the median pore diameter size of the first and/or second plurality of pores to the median ionic radius size of the counterion is about 1.05 or less, such as about 1.04 or less, such as about 1.03 or less, such as about 1.02 or less, such as about 1.01 or less.

Without intending to be limited by theory, the present inventors have discovered that the ultracapacitor can demonstrate enhanced results in some embodiments when the first carbonaceous coating and the second carbonaceous coating comprise different materials, resulting in the second carbonaceous coating comprising a second total pore volume with a different size distribution and porosity profile than the first total pore volume of the first carbonaceous coating. For instance, in some embodiments, the first carbonaceous coating has more micropores in its porosity profile and the second carbonaceous coating has more mesopores in its porosity profile. Without intending to be limited by theory, the present inventors believe that such a unique combination of porosity profiles may result in an ultracapacitor that has enhanced properties over a large operating temperature, especially when utilized with an ionic liquid that has a ratio of the amount of cation to counterion of about 1 to about 5.

The pore sizes and total pore volume for both the first carbonaceous coating and the second carbonaceous coating as discussed above may be measured using nitrogen adsorption and analyzed by the Barrett-Joyner-Halenda (“BJH”) technique as is well known in the art.

If desired, other materials may also be employed within an activated carbon layer of the first and/or second carbonaceous coatings and/or within other layers of the first and/or second carbonaceous coatings. For example, in certain embodiments, a conductivity promoter may be employed to further increase electrical conductivity. Exemplary conductivity promoters may include, for instance, carbon black, graphite (natural or artificial), graphite, carbon nanotubes, nanowires or nanotubes, metal fibers, graphenes, etc., as well as mixtures thereof. Carbon black is particularly suitable. When employed, conductivity promoters typically constitute about 60 parts or less, in some embodiments 40 parts or less, and in some embodiments, from about 1 to about 25 parts per 100 parts of the activated carbon particles in a carbonaceous coating. Conductivity promotes may, for example, constitute about 15 wt. % or less, in some embodiments about 10 wt. % or less, and in some embodiments, from about 0.5 wt. % to about 5 wt. % of the total weight of a carbonaceous coating. Activated carbon particles likewise typically constitute 85 wt. % or more, in some embodiments about 90 wt. % or more, and in some embodiments, from about 95 wt. % to about 99.5 wt. % of a carbonaceous coating.

The particular manner in which a carbonaceous coating is applied to a current collector may vary as is well known to those skilled in the art, such as printing (e.g., rotogravure), spraying, slot-die coating, drop-coating, dip-coating, etc. Regardless of the manner in which it is applied, the resulting electrode is typically dried to remove moisture from the coating, such as at a temperature of about 100° C. or more, in some embodiments about 200° C. or more. The electrode may also be compressed (e.g., calendered) to optimize the volumetric efficiency of the ultracapacitor. After any optional compression, the thickness of each carbonaceous coating may generally vary based on the desired electrical performance and operating range of the ultracapacitor. Typically, however, the thickness of a coating is about 20 micrometers or greater, about 30 micrometers or greater, and such as about 40 micrometers or greater. In other embodiments, the thickness of a coating is about 250 micrometers or less, such as about 200 micrometers or less, such as about 175 micrometers or less, such as about 170 micrometers or less, such as from about 150 micrometers or less, such as from about 100 micrometers or less. In certain embodiments, the thickness of a coating ranges from about 145 to about 210 micrometers. Coatings may be present on one or both sides of a current collector.

For instance, the thickness of the first carbonaceous coating may be about 150 micrometers or greater, such as about 160 micrometers or greater, such as about 170 micrometers or greater, such as about 180 micrometers or greater, such as about 190 micrometers or greater, such as about 200 micrometers or greater, such as about 210 micrometers or greater, and generally less than about 250 micrometers, such as about 240 micrometers or less, such as about 230 micrometers or less, such as about 210 micrometers or less. In certain embodiments, the first carbonaceous coating has a thickness of about 175 micrometers to about 210 micrometers. In other embodiments, the second carbonaceous coating has a thickness of about 110 micrometers or greater, such as about 120 micrometers or greater, such as about 130 micrometers or greater, such as about 140 micrometers or greater, and generally less than about 200 micrometers, such as about 190 micrometers or less, such as about 180 micrometers or less, such as about 170 micrometers or less. Thus, in other embodiments, the second carbonaceous coating has a thickness of about 145 micrometers to about 180 micrometers.

In certain embodiments, the first carbonaceous coating of the first electrode has a first thickness, the second carbonaceous coating of the second electrode has a second thickness, and the ultracapacitor has a ratio of the first thickness to the second thickness of from about 1.0 to about 2.5, such as from about 1.1 to about 2.0. For instance, in certain embodiments, the ratio of the first thickness to the second thickness is about 1.0 or greater, such as about 1.1 or greater, such as about 1.15 or greater, such as about 1.2 or greater, such as about 1.25 or greater, such as about 1.3 or greater, such as about 1.35 or greater, such as about 1.4 or greater, such as about 1.5 or greater, such as about 1.6 or greater. In other embodiments, the ratio of the first thickness to the second thickness is about 2.5 or less, such as about 2.0 or less, such as about 1.9 or less, such as about 1.8 or less, such as about 1.7 or less. In some embodiments, the ratio of the first thickness to the second thickness is about 1.1 to about 2.0, such as about 1.15 to about 1.3. In other embodiments, the ratio of the first thickness to the second thickness is about 1.2 to about 1.35.

Without intending to be limited by theory, the present inventors have discovered that utilizing the electrolyte system as described herein in combination with first and second electrodes having a ratio of the first thickness of the first carbonaceous coating to the second thickness of the second carbonaceous coating of greater than 1 surprisingly helps the resulting ultracapacitor to maintain better performance at both high and low temperatures, even when the same carbonaceous coating having the same or similar porosity profiles is utilized for both the first and second carbonaceous coatings.

As indicated above, the first electrode contains a first current collector and the second electrode contains a second current collector that are electrically coupled to the first carbonaceous coating and the second carbonaceous coating, respectively. It should be understood that additional current collectors may also be employed if desired, particularly if the ultracapacitor includes multiple energy storage cells. The current collectors may be formed from the same or different materials. Regardless, each collector is typically formed from a substrate that includes a conductive metal, such as aluminum, stainless steel, nickel, silver, palladium, etc., as well as alloys thereof. Aluminum and aluminum alloys are particularly suitable for use in the present invention. The substrate may be in the form of a foil, sheet, plate, mesh, etc. The substrate may also have a relatively small thickness, such as about 200 micrometers or less, in some embodiments from about 1 to about 100 micrometers, in some embodiments from about 5 to about 80 micrometers, and in some embodiments, from about 10 to about 50 micrometers. Although by no means required, the surface of the substrate may be optionally roughened, such as by washing, etching, blasting, etc.

In certain embodiments, at least one of the first and second current collectors, and preferably both, also contain a plurality of fiber-like whiskers that project outwardly from the substrate. Without intending to be limited by theory, it is believed that these whiskers can effectively increase the surface area of the current collector and also improve the adhesion of the current collector to the corresponding electrode. This can allow for the use of a relatively low binder content in the first electrode and/or second electrode, which can improve charge transfer and reduce interfacial resistance and consequently result in very low ESR values. The whiskers are typically formed from a material that contains carbon and/or a reaction product of carbon and the conductive metal. In one embodiment, for example, the material may contain a carbide of the conductive metal, such as aluminum carbide (Al₄C₃).

The manner in which such whiskers are formed on the substrate may vary as desired. In one embodiment, for instance, the conductive metal of the substrate reacts with a hydrocarbon compound. Examples of such hydrocarbon compounds may include, for instance, paraffin hydrocarbon compounds, such as methane, ethane, propane, n-butane, isobutane, pentane, etc.; olefin hydrocarbon compounds, such as ethylene, propylene, butene, butadiene, etc.; acetylene hydrocarbon compounds, such as acetylene; as well as derivatives or combinations of any of the foregoing. It is generally desired that the hydrocarbon compounds are in a gaseous form during the reaction. Thus, it may be desired to employ hydrocarbon compounds, such as methane, ethane, and propane, which are in a gaseous form when heated. Although not necessarily required, the hydrocarbon compounds are typically employed in a range of from about 0.1 parts to about 50 parts by weight, and in some embodiments, from about 0.5 parts by weight to about 30 parts by weight, based on 100 parts by weight of the substrate. To initiate the reaction with the hydrocarbon and conductive metal, the substrate is generally heated in an atmosphere that is at a temperature of about 300° C. or more, in some embodiments about 400° C. or more, and in some embodiments, from about 500° C. to about 650° C. The time of heating depends on the exact temperature selected but typically ranges from about 1 hour to about 100 hours. The atmosphere typically contains a relatively low amount of oxygen to minimize the formation of a dielectric film on the surface of the substrate. For example, the oxygen content of the atmosphere may be about 1% by volume or less.

The thickness of the overall electrode (including the current collector and the carbonaceous coating(s) after optional compression) is typically within a range of from about 20 to about 350 micrometers. For instance, in some embodiments, the thickness of the overall electrode is about 30 micrometers or greater, such as about 40 micrometers or greater, such as about 50 micrometers or greater, such as about 75 micrometers or greater, such as about 100 micrometers or greater, such as about 125 micrometers or greater, such as about 150 micrometers or greater, such as about 200 micrometers or greater. In other embodiments, the thickness of the overall electrode is about 350 micrometers or less, such as about 325 micrometers or less, such as about 300 micrometers or less, such as about 275 micrometers or less, such as about 250 micrometers or less, such as about 225 micrometers or less, such as about 200 micrometers or less. In some embodiments, the thickness of the overall electrode is from about 30 to about 300 micrometers such as from about 50 to about 250 micrometers.

In some embodiments, the positive electrode is thicker than the negative electrode. Without intending to be limited by theory, the present inventors have discovered that, when the positive electrode is thicker than the negative electrode, the resulting ultracapacitor may demonstrate higher voltage retention rates and higher specific capacitance. For instance, the present inventors have found that the positive electrode may have a greater impact on the voltage retention rate of the ultracapacitor than the negative electrode, because the positive electrode has a high ion migration capability due to its small ion size. According to Ohm's law, the voltage retention rate of the ultracapacitor is inverse to the cell voltage or electrode potential. Therefore, the higher the voltage, the lower the voltage retention rate, meaning the ultracapacitor is more likely to “self-discharge” and therefore not be a reliable energy source. Resultingly, the present inventors have found that by selectively controlling the thickness of the first electrode and the first carbonaceous coating, the resulting ultracapacitor is better suited for use in a wide variety of temperatures.

For instance, the present inventors have found that the electrode thickness balance can be manipulated based on the specific electrolyte utilized based on these charge equations:

$${Q}_{+} = {C}_{+}^{⋆} Δ {V}_{+}$$

wherein Q₊ is the charge of the first electrode, C₊ is the capacitance of the first electrode, and ΔV₊ is the change in voltage of the first electrode.
and

$${Q}_{-} = {C}_{-}^{⋆} Δ {V}_{-}$$

wherein Q₋ is the charge of the second electrode, C₋ is the capacitance of the second electrode, and ΔV₋ is change in voltage of the second electrode.

Due to the law of electroneutrality, therefore Q₊=C₊*ΔV₊=Q₋=C₋*ΔV₋.

Thus, if the first electrode is thicker than the second electrode, then

$${C}_{+} > {C}_{-} and Δ {V}_{+} < Δ {V}_{-}$$

Therefore, manipulating the change in voltage of the first electrode (e.g., ΔV₊) to be less than the change in voltage of the second electrode (e.g., ΔV₋) can help minimize the overall change of voltage for the ultracapacitor (e.g., voltage retention rate).

Further, the present inventors have discovered that at higher temperatures, the positive electrode potential shifts to the negative direction if the positive electrode is thicker than the negative electrode. Thus, utilizing a thicker positive electrode than a negative electrode, in combination with the electrolyte system as described herein, may help the resulting ultracapacitor have better electrochemical properties over a wider range of temperatures, as increasing the thickness of the positive electrode helps suppress the positive electrode's potential shift to the electrolyte oxidation zone during charging and discharging.

The present inventors have also discovered that in addition to selectively controlling the thickness of the positive and negative electrodes, that also controlling the placement and pairing of the electrodes may help shift the oxidation potential. In some embodiments, when the electrodes and separator are wound into an electrode assembly, the end section of the first and/or second electrode may be unpaired. For instance, if the electrodes are double-sided coating electrodes, the end section of the first and/or second electrode may be unpaired such that it is positioned on an outer perimeter of the jellyroll configuration, where there is no counter electrode for charge balance. Without intending to be limited by theory, the present inventors have found that utilizing an unpaired second electrode that is positioned on an outer perimeter of the jellyroll configuration may help improve the resulting ultracapacitor's electrochemical properties. As the outer perimeter of the jellyroll configuration is exposed, it is believed that the outer perimeter of the jellyroll configuration is critical to high temperature performance and to reducing self-discharge behavior. Thus, the present inventors believe that utilizing a negative electrode on the perimeter of the jellyroll configuration results in better electrochemical system stability, compared to if a positive electrode is utilized as the unpaired electrode on the perimeter of the jellyroll configuration. Thus, as the positive electrode may have a greater impact on the voltage retention rate of the ultracapacitor than the negative electrode, in preferred embodiments the positive electrode is shielded within the jellyroll configuration and the negative electrode is exposed on the outer periphery of the jellyroll configuration.

In certain embodiments, the second electrode is positioned on an outer perimeter of the jellyroll configuration and the second electrode is thicker than the first electrode. However, in preferred embodiments, the second electrode is positioned on an outer perimeter of the jellyroll configuration and the first electrode is thicker than the second electrode. However, it should be understood that other configurations may also be utilized.

As indicated, the ultracapacitor also includes a separator. The separator is positioned between the first and second electrodes. If desired, other separators may also be employed in the ultracapacitor of the present invention. For example, one or more separators may be positioned over the first electrode, the second electrode, or both. The separators enable electrical isolation of one electrode from another to help prevent an electrical short but still allow transport of ions between the two electrodes. The separators can also act as electrolyte reservoirs. In certain embodiments, for example, a separator may be employed that includes a cellulosic fibrous material (e.g., airlaid paper web, wet-laid paper web, etc.), nonwoven fibrous material (e.g., polyolefin nonwoven webs), woven fabrics, film (e.g., polyolefin film), etc. Cellulosic fibrous materials are particularly suitable for use in the ultracapacitor, such as those containing natural fibers, synthetic fibers, etc. Specific examples of suitable cellulosic fibers for use in the separator may include, for instance, hardwood pulp fibers, softwood pulp fibers, rayon fibers, regenerated cellulosic fibers, etc.

Regardless of the particular materials employed, the separator typically has a thickness of from about 5 to about 150 micrometers, in some embodiments from about 10 to about 100 micrometers, and in some embodiments, from about 20 to about 80 micrometers. Without intending to be limited by theory, the present inventors have found that the thicker the separator, the higher the voltage retention rate is for the ultracapacitor, meaning that it is less likely to “self-discharge.” For instance, a thicker separator allows for more ions in the separator, which are harder to deplete after the ultracapacitor has been completely charged. For instance, if the ions were to be depleted from the separator, the conductivity of the electrolyte would decrease, resulting in a high ion concentration gradient which is more likely to influence self-discharge behavior of the ultracapacitor. Whereas the thicker the separator, the more difficult it is to deplete the ions from the separator.

Additionally, the present inventors have found that the separator also serves as an electron insulator. For instance, the present inventors have also found that the resistance of the separator may also depend on the thickness and surface area of the separator. According to Ohm's law, which holds that current is equivalent to voltage/resistance (e.g., I=V/R), the ultracapacitor may have a lower leakage current, and therefore a lower self-discharge rate if the resistance of the ultracapacitor is higher.

The ultracapacitor of the present invention is not necessarily limited and can be produced in a shape such as a film type, a coin type, a cylindrical type, an oval (non-cylindrical) shape, and a box shape, and is not particularly limited. For instance, examples of these ultracapacitors includes cylindrical cells, prismatic cells, surface mountable cells, etc.

The ultracapacitor of the present invention employs a housing within which the electrode assembly and the electrolyte system are retained. The manner in which the components are inserted into the housing may vary as is known in the art. For example, the electrodes and separator may be initially folded, wound, stacked, or otherwise contacted together to form an electrode assembly. The electrolyte may optionally be immersed into the electrodes of the assembly. In one particular embodiment, the electrodes and separator may be wound into an electrode assembly having a “jelly-roll” configuration. For example, the electrode assembly may include a jellyroll electrode assembly that contains a first electrode, a second electrode, and a separator positioned between the electrodes. In one embodiment, the electrode assembly may also include another separator that is positioned over the second electrode. In this manner, each of two coated surfaces of the electrodes is separated by a separator, thereby maximizing surface area per unit volume and capacitance. While by no means required, the electrodes can be offset in this embodiment so as to leave their respective contact edges extending beyond first and second edges of the first and second separators, respectively. Among other things, this can help prevent “shorting” due to the flow of electrical current between the electrodes. However, it should be understood that other configurations may also be utilized. For instance, in another embodiment, the electrodes, separator, and optional electrolyte may be provided as an electrode assembly having a laminar configuration. In some embodiments, when the electrodes and separator are wound into an electrode assembly, the first and/or second electrode may be “unpaired,” such that it is positioned on an outer perimeter of the jellyroll configuration. Thus, in certain embodiments, the jellyroll configuration has a second electrode (e.g., “negative” electrode) that is unpaired and that is positioned on an outer perimeter of the jellyroll configuration.

Furthermore, the jellyroll may be provided in a circular/cylindrical configuration in one embodiment. In another embodiment, the jellyroll may be provided in a relatively flatter circular/cylindrical (or oval) configuration.

The nature of the housing may vary as desired. In certain embodiments, for example, the housing may contain a container that encloses the components of the ultracapacitor. For example, the housing may contain a metal container (“can”), such as those formed from tantalum, niobium, aluminum, nickel, hafnium, titanium, copper, silver, steel (e.g., stainless), alloys thereof, composites thereof (e.g., metal coated with electrically conductive oxide), and so forth. Aluminum is particularly suitable for use in the present invention. The metal container may have any of a variety of different shapes, such as cylindrical, oval, D-shaped, etc. Cylindrically-shaped containers are particular suitable.

In other embodiments, the housing may be in the form of a package. For instance, the package may include sidewalls that extend in a direction generally perpendicular to a base to define an upper end wherein the base defines an inner surface and an outer surface. Any of a variety of different materials may be used to form the sidewalls and base, such as metals, plastics, ceramics, and so forth. In one embodiment, for example, the sidewalls and/or base may include one or more layers of a ceramic material, such as aluminum nitride, aluminum oxide, silicon oxide, magnesium oxide, calcium oxide, glass, etc., as well as combinations thereof. In other embodiments, the sidewalls and/or base may include one or more layers of a metal, such as tantalum, niobium, aluminum, nickel, hafnium, titanium, copper, silver, steel (e.g., stainless), alloys thereof (e.g., electrically conductive oxides), composites thereof (e.g., metal coated with electrically conductive oxide), and so forth.

In other embodiments, the package may be a flexible package. The flexible package generally includes a substrate that extends between two ends and that has edges. The ends and the sides of the package overlap and are fixedly and sealingly abutted against one another (e.g., by heat welding). In this manner, the electrolyte can be retained with the package. The substrate typically has a thickness within the range of from about 20 micrometers to about 1,000 micrometers, in some embodiments from about 50 micrometers to about 800 micrometers, and in some embodiments, from about 100 micrometers to about 600 micrometers.

The substrate of the flexible package may contain any number of layers desired to achieve the desired level of barrier properties, such as 1 or more, in some embodiments 2 or more, and in some embodiments, from 2 to 5 layers. Typically, the substrate contains a barrier layer, which may include a metal, such as aluminum, nickel, tantalum, titanium, stainless steel, etc. Such a barrier layer is generally impervious to the electrolyte so that it can inhibit leakage thereof, and also generally impervious to water and other contaminants. If desired, the substrate may also contain an outer layer that serves as a protective layer for the package. In this manner, the barrier layer is positioned between the outer layer and the electrode assembly. The outer layer may, for instance, be formed from a polymer film, such as those formed from a polyolefin (e.g., ethylene copolymers, propylene copolymers, propylene homopolymers, etc.), polyesters, etc. Particularly suitable polyester films may include, for example, nylon, polyethylene terephthalate, polyethylene naphthalate, polybutylene terephthalate, etc.

If desired, the substrate may also contain an inner layer that is positioned between the electrode assembly and the barrier layer. In certain embodiments, the inner layer may contain a heat-sealable polymer. Suitable heat-sealable polymers may include, for instance, polyethylene, polypropylene, vinyl chloride polymers, ionomers, etc., as well as combinations thereof. Ionomers are particularly suitable. In one embodiment, for instance, the ionomer may be a copolymer that contains an α-olefin and (meth)acrylic acid repeating unit. Specific α-olefins may include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Ethylene is particularly suitable. As noted, the copolymer may also be a (meth)acrylic acid repeating unit. As used herein, the term “(meth)acrylic” includes acrylic and methacrylic monomers, as well as salts or esters thereof, such as acrylate and methacrylate monomers. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. Typically, the α-olefin/(meth)acrylic acid copolymer is at least partially neutralized with a metal ion to form the ionomer. Suitable metal ions may include, for instance, alkali metals (e.g., lithium, sodium, potassium, etc.), alkaline earth metals (e.g., calcium, magnesium, etc.), transition metals (e.g., manganese, zinc, etc.), and so forth, as well as combinations thereof. The metal ions may be provided by an ionic compound, such as a metal formate, acetate, nitrate, carbonate, hydrogen carbonate, oxide, hydroxide, alkoxide, and so forth.

Within the housing, first and second conductive members may also be employed within the interior cavity to facilitate the connection of the electrode assembly in a mechanically stable manner. For example, a first conductive member and a second conductive member may be disposed on the inner surface of the base and extend in a plane that is generally parallel to the base. The conductive members may be provided in any form (e.g., pad, plate, frame, etc.), but generally have a relatively small thickness or to minimize the thickness of the resulting ultracapacitor. The conductive members may be formed from one or more layers of a metal, such as nickel, silver, gold, tin, copper, etc. The leads of the electrode assembly that are connected to the respective electrodes may be electrically connected to the respective conductive members. The leads may be attached using any of a variety of known techniques, such as welding, laser welding, conductive adhesives, etc.

The first and second conductive members may be electrically connected to first and second external terminations, respectively, which may be provided on the outer surface of the base and extend in a plane that is generally parallel to the base. The terminations may be provided in any form (e.g., pad, plate, frame, etc.), but generally have a relatively small thickness or to minimize the thickness of the resulting ultracapacitor and improve its ability to be surface mounted to a circuit board. The terminations may be formed from one or more layers of a metal, such as nickel, silver, gold, tin, copper, etc. If desired, the surface of the terminations may be electroplated with nickel, silver, gold, tin, etc. as is known in the art to ensure that the final part is mountable to the circuit board. In one particular embodiment, the termination(s) may be deposited with nickel and silver flashes, respectively, and the mounting surface is also plated with a tin solder layer. In another embodiment, the termination(s) may be deposited with thin outer metal layers (e.g., gold) onto a base metal layer (e.g., copper alloy) to further increase conductivity.

Regardless of the manner in which they are formed, the first and second external terminations may be electrically connected to the first and second conductive members, respectively, to provide the desired connection with the electrode assembly. In one embodiment, for instance, the conductive members may simply extend through the base to form the external terminations. Alternatively, a separate conductive trace may be attached to the first conductive member that extends through the base and either forms the first external termination or is connected to an additional conductive member that serves as the external termination. Similarly, the second conductive member may extend through the base to form the external termination, or a separate conductive trace (not shown) may be attached to the second conductive member that extends through the base and either forms the termination or is connected to an additional conductive member that serves as the termination. When traces are employed, a via may be formed within the base to accommodate the trace.

The manner in which the conductive members and external terminations may be electrically connected may vary as is known in the art. In certain embodiments, for example, welding techniques may be employed, such as ultrasonic welding, laser welding, resistance welding, etc. In yet other embodiments, a conductive adhesive may be employed to connect the conductive members to respective terminations.

Once connected in the desired manner, the electrode assembly may then be sealed within the housing. For instance, the ultracapacitor may also include a lid that is positioned on the upper end of the sidewalls after the electrode assembly is positioned within the housing. The lid may be formed from a ceramic, metal (e.g., iron, copper, nickel, cobalt, etc., as well as alloys thereof), plastic, and so forth. If desired, a sealing member (not shown) may be disposed between the lid and the sidewalls to help provide a good seal. In one embodiment, for example, the sealing member may include a glass-to-metal seal, Kovar® ring (Goodfellow Camridge, Ltd.), etc. The height of the sidewalls is generally such that the lid does not contact any surface of the electrode assembly. When placed in the desired position, the lid may be sealed to the sidewalls using known techniques, such as welding (e.g., resistance welding, laser welding, etc.), soldering, etc. In certain embodiments, the electrodes, the separator, and the electrolyte system are hermetically sealed within the housing. Hermetic sealing is the process of creating an airtight container that prevents the leakage of gases, liquids, or solids.

The embodiments described above generally refer to the use of a single electrode assembly in the ultracapacitor. It should of course be understood, however, that the capacitor of the present invention may also contain two or more electrode assemblies. For instance, in one such embodiment, for example, the ultracapacitor may include a stack of two or more electrode assemblies, which may be the same or different.

The ultracapacitor as disclosed herein can be utilized for various applications. For instance, the ultracapacitor may be utilized alone or may be provided as an ultracapacitor module.

In general, the ultracapacitor module includes a plurality of ultracapacitors and an enclosure for housing the plurality of ultracapacitors. The number of ultracapacitors utilized within the module are not necessarily limited by the present invention. For instance, the module may include at least 2, such as at least 4, such as at least 6, such as at least 10, such as at least 14, such as at least 18, such as at last 24, such as at last 30, such as at last 40, such as at least 50 ultracapacitors, such as at least 54 ultracapacitors. While not limited, the module may include 500 or less, such as 400 or less, such as 300 or less, such as 200 or less, such as 100 or less, such as 80 or less, such as 60 or less, such as 40 or less ultracapacitors.

The ultracapacitors within the ultracapacitor module may be connected to one another using means known in the art. For instance, the ultracapacitors may be connected using an interconnect (also referred to as a bus bar). In addition, the ultracapacitors may be electrically connected together in series or in parallel, depending on the particular properties desired. For instance, in one embodiment, the ultracapacitors may be electrically connected in series such that a terminal of a certain polarity (e.g., positive) of one ultracapacitor is connected to a terminal of opposite polarity (e.g., negative) of another ultracapacitor. Alternatively, in one embodiment, the ultracapacitors may be connected in parallel.

The type of interconnect and material utilized is not necessarily limited by the present invention. For instance, the interconnect may be formed from a variety of materials. The interconnect may comprise any suitable plastic, resin, metal, etc. so long as it is electrically conductive. In one embodiment, the interconnect is formed from a conductive material, such as a conductive metal. The conductive metal may include, but is not limited to, copper, tin, nickel, aluminum, etc., as well as alloys and/or coated metals. In one particular embodiment, the interconnect is formed from aluminum. In addition, in one embodiment, the interconnect may be relatively flat. Alternatively, the interconnect may be one having an increased surface area. Regarding the latter, the interconnect may have projections/protrusions or may also be formed from wires, braids, coils, etc.

Regardless, the ultracapacitors may be connected using an interconnect that attaches to or connects the respective terminals of the ultracapacitors. In this regard, the interconnect includes voids in which the terminals of the ultracapacitors are positioned. The interconnect surrounds the terminal allowing for electrical connection. The interconnect may be welded, such as laser welded, to the terminal of the ultracapacitors. However, it should be understood that other means may also be employed for connecting the interconnect to the terminals of the ultracapacitors. For instance, if the terminals have a screw configuration, the terminals may protrude through the voids of the interconnects whereby a nut could be utilized to connect the interconnect with the terminal and maintain structural integrity. It should be understood that in addition to the above, other means may also be utilized to secure the interconnect to the respective terminal.

The ultracapacitor module may also include an electronic board, such as a circuit board. For example, the circuit board may be a balancing circuit as generally known in the art. In general, the balancing circuit may be an active balancing circuit or a passive balancing circuit. For example, an active balancing circuit may include active components, such as a regulator. In general, a regulator can be any device that is operable to compare the input voltage with the reference voltage and provide an output. In some embodiments, the regulator can include a comparator and/or one or more switching elements provided in a single package (e.g., integrated circuit). Meanwhile, a passive balancing circuit may include passive components, such as a resistor. As indicated below, the ultracapacitors may be presented in banks. In this regard, in one embodiment, each individual bank may have its own circuit board.

The ultracapacitor module may also include a control board. The control board may include electronic components to assist with the operation of the ultracapacitor module as well as an end-use application. The control board may be secured to the ultracapacitor module. As indicated below, the ultracapacitors may be presented in banks. In this regard, in one embodiment, each individual bank may have its own control board.

The ultracapacitor module may include a switch mode power supply on its output. For instance, the ultracapacitor module may include a converter. The converter may be a buck converter, a boost converter, or a buck/boost converter. In one embodiment, the converter may be a buck/boost converter. In another embodiment, the converter may be a buck converter. In a further embodiment, the converter may be a boost converter. In this regard, if the voltage of the ultracapacitors is affected, the converter may allow for the output voltage of the ultracapacitor module to be as desired. For example, in one embodiment, the output voltage may be converted to be about 48 V.

In another embodiment of the present disclosure, the ultracapacitor may be utilized in an energy reserve system for an electronic latch assembly. Electronic latch (e.g. “e-latch”) assemblies may be used in a variety of applications, including but not limited to vehicles and asset security systems. For instance, electronic latch assemblies are particularly useful in vehicles and can act as life-saving equipment when installed in vehicle doors. E-latch assemblies may be able to open vehicle doors by quickly releasing the ultracapacitor's energy when a main power supply, such as the battery, is disconnected due to an emergency, like an accident or loss of power.

In certain embodiments, the energy reserve system for an electronic latch assembly comprises an electronic control unit which is connected to a locking mechanism of the electronic latch assembly and at least two ultracapacitors that are conductively connected. The at least two ultracapacitors may be conductively connected in series or in parallel.

The electric control unit may include one or more controllers and various other components configured to be communicatively coupled to and/or controlled by the controller(s). It should be appreciated that the controller(s) may correspond to any suitable processor-based device(s), such as a single controller or any combination of computing devices. Thus, the controller(s) may generally include one or more processors and associated memory devices configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and any other programmable circuits. Additionally, the memory 180 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory may generally be configured to store information accessible to the processor(s), including data that can be retrieved, manipulated, created and/or stored by the processor(s) and instructions that can be executed by the processor(s).

The energy reserve system can also comprise a primary energy source, such as a battery. If the primary energy source is operating properly, the primary energy source can provide power to the electronic latch assembly such that the locking mechanism can be configured to an unlocked position or locked position, depending on the user's preference. However, when the primary energy source is not available, the electronic control unit directs voltage from the at least two ultracapacitors upon determining the primary energy source is not available.

The electronic control unit is configured to direct the voltage from the at least two ultracapacitors such that the locking mechanism can move the lock to either an unlocked or locked position. This allows users or passengers to be able to open the doors they need access to in a safe and timely manner. This is especially necessary for users in scenarios where the primary energy source is no longer available, such as during emergencies or car accidents. In certain embodiments, the energy reserve system comprises at least two ultracapacitors as described herein. In preferred embodiments, for the energy reserve system to be a reliable source of energy, each ultracapacitor may comprise a first electrode, a second electrode, a separator, an electrolyte system, and a housing. The first electrode comprises a first current collector electrically coupled to a first carbonaceous coating, the second electrode comprises a second current collector electrically coupled to a second carbonaceous coating, and the separator is positioned between the first electrode and the second electrode. The electrolyte system in ionic contact with the first electrode and the second electrode, wherein the electrolyte system comprises a sulfur-containing compound having a boiling point of about 200° C. or greater, a nonaqueous solvent having a boiling point of about 200° C. or less, and an ionic liquid comprising a cationic species and a counterion dissolved in the nonaqueous solvent. The housing retains the first electrode, the second electrode, the separator, and the electrolyte system. Notably, the first carbonaceous coating has a first thickness, the second carbonaceous coating has a second thickness, and the ratio of the first thickness to the second thickness if from about 1.0 to about 2.5.

The ultracapacitor of the present disclosure may be particularly suitable for the use in a vehicle with an energy reserve system as described above. The vehicle can comprise a frame and at least one door. Vehicles can include, but are not limited to, a motor vehicle (e.g., cars, vans, trucks, carts, etc.), aircraft (e.g., airplanes, helicopters, etc.), watercraft (e.g., boats, ships, submersibles, submarines, etc.), and spacecraft. In certain embodiments, the energy reserve system comprises an electronic control unit which is connected to a locking mechanism of the electronic latch assembly. In certain embodiments, the electronic control unit may also comprise the primary energy source, such as a battery. The energy reserve system comprises at least two ultracapacitors as described herein that are conductively connected. The at least two ultracapacitors provide voltage to the electronic control unit, for instance, upon determining the primary energy source is not available.

Without intending to be limited by theory, the present inventors believe that utilizing an ultracapacitor that employs the electrolyte system as described above in combination with a first and second electrode that have a ratio of the first thickness of the first carbonaceous coating to the second thickness of the second carbonaceous coating of greater than 1 is particularly well suited for use in applications that must be able to function over a wide operating temperature range, such as in both cold and hot temperatures. For instance, one such application is for use in vehicles (e.g., electric vehicles and hybrid vehicles), as vehicles must be operated in both cold climates and warm climates. Thus, in certain embodiments, the ultracapacitors may be useful in automotive applications (e.g., start-stop systems, cold start assistance, and energy stabilization systems). Further, the ultracapacitors as described herein may be used in other applications that require performance at wide operating temperatures, including, but not limited to, construction equipment, agricultural machinery, energy harvesting, and wind turbines.

As discussed above, the resulting ultracapacitors as disclosed herein have improved electrochemical properties. For instance, ultracapacitors that were aged for 16 hours at 65° C. and at 2.7 V, fully discharged to 0 V for at least two hours to obtain an initial capacitance and ESR measurement according to IEC method, and then placed in an 85° C. oven and held at a voltage of 2.7 V for endurance testing demonstrated improved reliability in comparison to ultracapacitors subjected to the same endurance testing that had a different electrolyte system.

In some embodiments, the resulting ultracapacitors with the electrolyte system as disclosed herein were able to retain greater than about 60% of the initial capacitance after multiple hours (e.g., 400, 600, 800, 1000, 2000, 3000, 4000) of testing, even at high temperatures and high voltages. For instance, the capacitors were able to retain greater than about 65% of the initial capacitance, such as greater than about 70% of the initial capacitance, such as greater than about 75% of the initial capacitance, such as greater than about 80% of the initial capacitance, such as greater than about 85% of the initial capacitance, such as greater than about 86% of the initial capacitance, such as greater than about 87% of the initial capacitance, such as greater than about 88% of the initial capacitance, such as greater than about 89% of the initial capacitance, and even greater than about 90% of the initial capacitance. In other embodiments, the resulting ultracapacitors with the electrolyte system as described herein were able to retain about 20% or more of the initial capacitance compared to the ultracapacitor that did not have the electrolyte system as disclosed herein, such as about 15% or more, such as about 10% or more, such as about 5% or more, such as about 4% or more, such as about 3% or more, such as about 2% or more, such as about 1% or more.

In other embodiments, the resulting ultracapacitors with the electrolyte system as described herein were able to have much lower increases in ESR gain in comparison to the ultracapacitors that did not have the electrolyte system as described herein, even when tested at high temperatures and high voltages. For instance, the resulting ultracapacitors with the electrolyte systems as described herein had about 250% or less of the initial ESR after multiple hours (e.g., 400, 600, 800, 1000, 2000, 3000, 4000), such as about 225% or less, such as about 200% or less, such as about 180% or less, such as about 175% or less, such as about 150% or less, such as about 130% or less.

The present invention may be better understood with reference to the following example.

### Test Methods

### Equivalent Series Resistance (ESR)

Equivalence series resistance may be measured using a Hiller Instrument or Arbin Instrument by the IEC-62391 (2022) method. A variety of temperature levels may be tested. For example, the temperature may be 23° C., 65° C., 85° C. 105° C., or 125° C., and the relative humidity may be 25% or 85%.

### Capacitance

The capacitance may be measured using a Hiller Instrument or Arbin Instrument by the IEC-62391 (2022) method. A variety of temperature levels may be tested. For example, the temperature may be 23° C., 65° C., 85° C., 105° C. or 125° C., and the relative humidity may be 25% or 85%.

### Ionic Radius Size

The ionic radius is the effective distance between the nucleus's center and the electronic cloud where the ion exerts its influence. The ionic radius size may be measured using Pauling's method. Pauling's method holds that in an ionic crystal type of M⁺X⁻, cations and counterions are in contact with each other. Therefore, the sum of their ionic radius is equal to the interionic distance. Therefore, we can determine the value of the cationic radius or the counterion radius:

$${r}_{M}^{+} + {r}_{X}^{-} = ( c / ( {Z}_{eff} ( {M}^{+} ) ) + ( c / {Z}_{eff} ( {X}^{-} ) ) ( pm )$$

wherein Z_{eff} is the effective nuclear charge. Z_{eff}=Z−σ; where σ is the screening constant.

Therefore, the ionic radius of the cationic species is;

$${r}_{M}^{+} = ( c / ( {Z}_{eff} ( {M}^{+} ) )$$

and the ionic radius of the counterion is:

$${r}_{X}^{-} = ( c / {Z}_{eff} ( {X}^{-} ) )$$

### Voltage Retention Rate

The voltage retention rate (e.g. “self-discharge” rate) of a single ultracapacitor may be measured by aging the ultracapacitor for 16 hours at 65° C. and 2.7 volts before fully discharging to 0 volts at less two hours. The ultracapacitors were first charged to 2.5 volts using a constant current of 0.25 Å, and held at 2.5 volts until the charging current was 10 mA. Once the charging current was 10 mA, the power source was turned off and the cell voltage was monitored for 16 hours. The difference in initial voltage when the power source was turned off to the final voltage tested after 16 hours is then calculated as the ultracapacitor's voltage retention rate. For instance:

$$Voltage Retention Rate \% = Δ V = ( {V}_{f} / {V}_{i} ) \times 100$$

wherein V_{f} is the final voltage tested after 16 hours and Vᵢ is the initial voltage.

### EXAMPLE 1

The ability to form an electrochemical cell in accordance with the present invention was demonstrated. Initially, each side of two aluminum current collectors (thickness of 12 to 50 μm) containing aluminum carbide whiskers or etched aluminum foils were coated utilizing an industrial coater with a slurry mixture of 70-95 wt. % (solid content) of activated carbon particles, 2-10 wt. % of a styrene-butadiene copolymer, 1-4 wt. % of sodium carboxymethylcellulose, and water solvent. The thickness of each resulting coating was obtained by tuning coating speed and slurry feeding gap. The first electrode coating had a thickness of 210 μm and the second electrode coating had a thickness of 180 μm.

The carbonaceous coating on the electrodes comprised an activated carbon with median pore diameter sizes of less than about 2 nanometers in size (i.e., “micropores”) of about 50 vol. % or less and the amount of pores between about 2 nanometers and about 50 nanometers in size (i.e., “mesopores”) of from about 20 vol. % to about 80 vol. %, and the amount of pores greater than about 50 nanometers in size (i.e., “macropores”) may be from about 1 vol. % to about 50 vol. %. The BET Surface Area of the activated carbon of the second carbonaceous coating was from about 1350 m²/g to about 1400 m²/g. The single point adsorption total pore volume of pores less than 3,604.993 Å width at p/p°=0.994729757 of the activated carbon in the second carbonaceous coating was from about 0.700 m³/g to about 0.800 m³/g.

The electrodes were then calendared and dried under vacuum at a temperature of from 70° C. to 200° C. Once dried, the electrodes were slitted to the desired size. Once formed, the two electrodes were assembled with an electrolyte and a separator (cellulose material having a thickness of 25 μm or 30 μm) and wound to form “jelly rolls” according to the designed diameter size. The jelly rolls were then completely dried confirming by the Karl-Fischer titration method. After the jelly rolls were dried, an electrolyte according to Table 1 was added into a tray filled with jelly rolls so that the jellyrolls were saturated with the electrolyte.

TABLE 1
Electrolyte Composition for Example 1

| Electrolyte Component | wt. % |
|---|---|
| spiro-(1,1′)-bipyrrolidinium | 32 wt. % |
| tetrafluoroborate | |
| sulfolane | 44 wt. % |
| acetonitrile | 19 wt. % |
| dimethyl sulfone | 5 wt. % |

A portion of the jellyrolls were inserted with a rubber gasket into an aluminum can and the aluminum can was crimped for cell sealing.

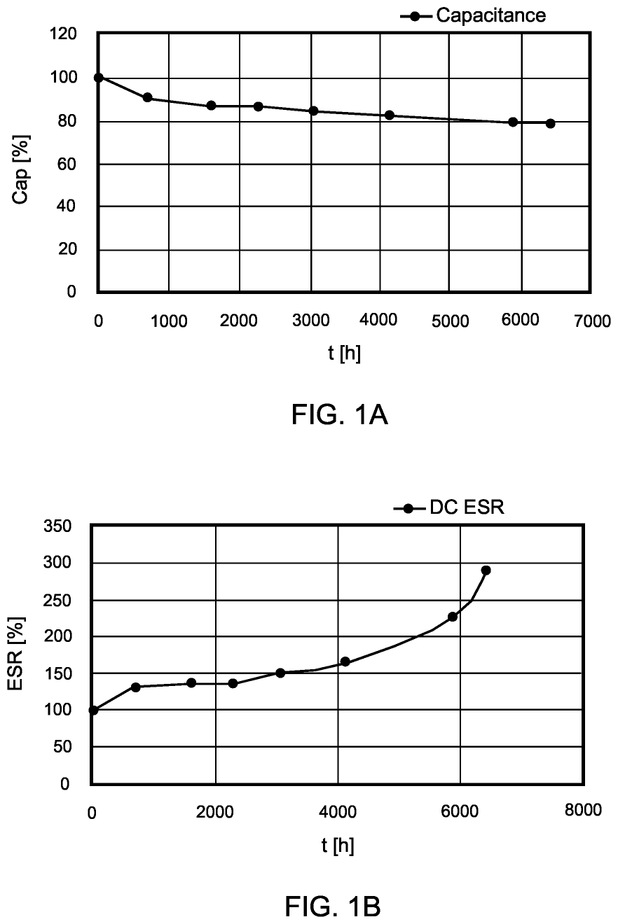

The ultracapacitors then aged for 16 hours at 65° C. and at 2.7 V. The ultracapacitors were then fully discharged to 0 V for at least two hours to obtain an initial capacitance and ESR measurement according to IEC method. The ultracapacitors were then placed in an 85° C. oven and held at a voltage of 2.7 V for endurance testing. After a predetermined period of time, the ultracapacitors were removed from the oven and cooled down to room temperature. Once the ultracapacitors had cooled, measurements of their capacitance and ESR after discharging them to 0 V for at least 2 hours were obtained. The results are set forth in FIG. 1A and FIG. 1B.

### EXAMPLE 2

The jelly roll configurations of electrodes and separators were prepared, assembled, and dried in the same manner as described in Example 1, except that the electrolyte contained spiro-(1,1′)-bipyrrolidinium tetrafluoroborate at a concentration of 1.0 M in acetonitrile. The jellyrolls were then subjected to the same endurance testing as described in Example 1.

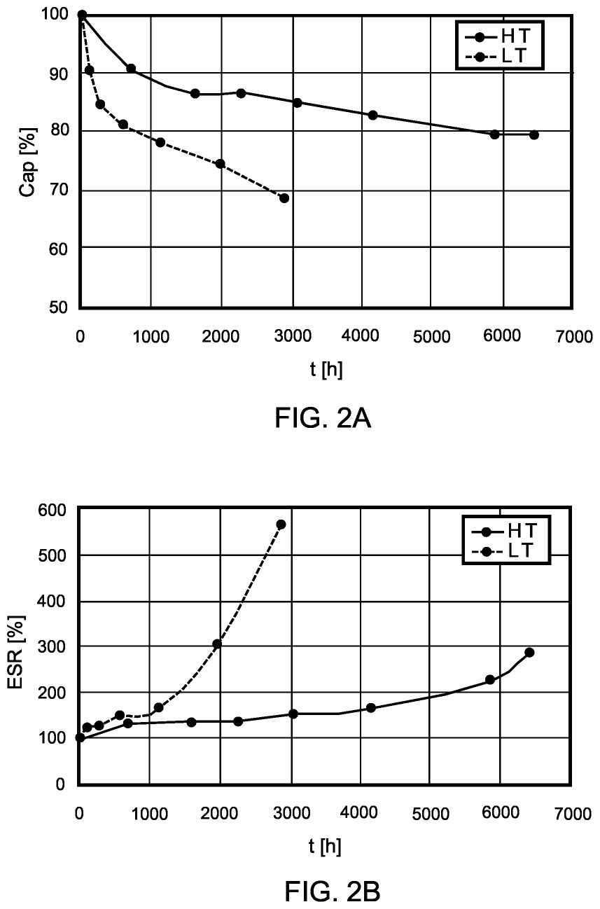

As demonstrated by FIG. 2A and FIG. 2B, not all electrolytes have the same effect on capacitance and ESR. For instance, in comparison to the jellyrolls prepared in Example 1 (“HT”), the jellyrolls prepared with the electrolyte that contained only spiro-(1,1′)-bipyrrolidinium tetrafluoroborate at a concentration of 1.0 M in acetonitrile (“LT”) demonstrated lower capacitance retention rates and higher ESR gain rates.

### EXAMPLE 3

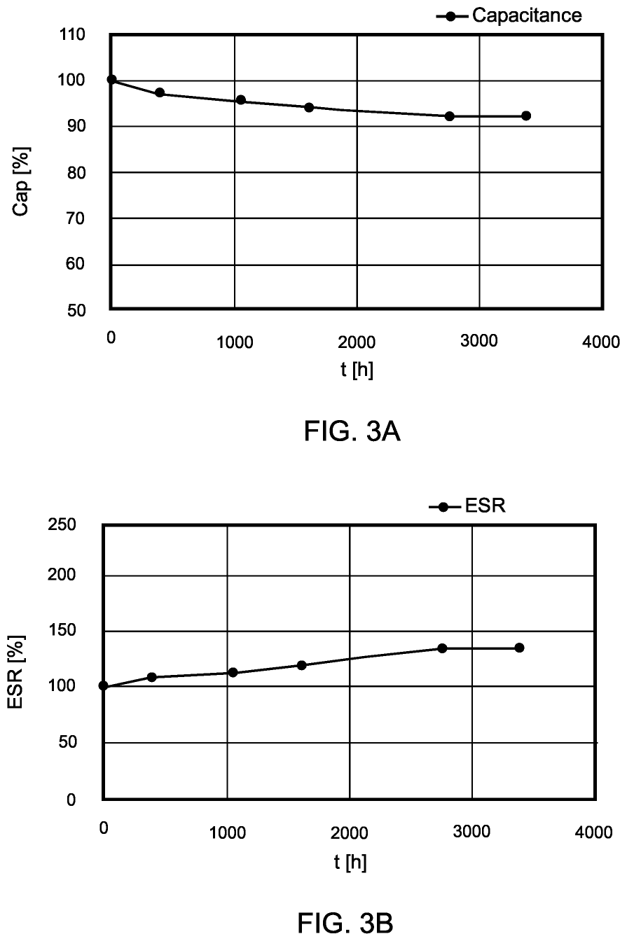

The electrodes were prepared in the same manner as in Example 1. The jellyrolls were then subjected to the same endurance testing as described in Example 1, except that the floated voltage was 1.5 V and the test chamber was at a temperature of 105° C. The results are set forth in FIG. 3A and FIG. 3B.

### EXAMPLE 4

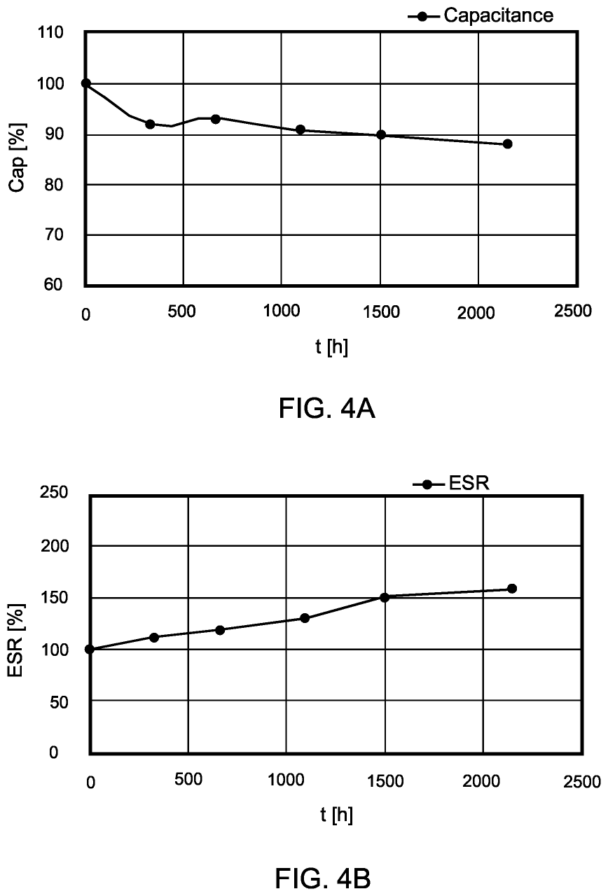

The electrodes were prepared in the same manner as in Example 1. The jellyrolls were then subjected to the same endurance testing as described in Example 1, except that the floated voltage was 1.8 V and the test chamber was at a temperature of 105° C. The results are set forth in FIG. 4A and FIG. 4B.

### EXAMPLE 5

The electrodes were prepared in the same manner as in Example 1, except that the first electrode coating was formed to be 175 μm thick and the second electrode coating was formed to be 145 μm thick. The jellyrolls were configured such that when they were wound, the first coating is unpaired and is positioned on an outer perimeter of the jellyroll configuration. Different activated carbon particles were also utilized for the electrodes. The carbonaceous coating on the electrodes comprised activated carbon with about 50 vol. % or more of pores having a median pore diameter size of about 2 nanometers (i.e., “micropores”) or less, such as greater than about 65 vol. % or more of pores having a median pore diameter size of about 2 nanometers or less, such as greater than about 75 vol. % or more of pores having a median pore diameter size of about 2 nanometers or less. The BET Surface Area of the activated carbon of the carbonaceous coatings was from about 1600 m²/g to about 1750 m²/g. The single point adsorption total pore volume of pores less than 3,604.993 Å width at p/p°=0.994729757 of the activated carbon in the carbonaceous coatings was from about 0.880 m³/g to about 0.916 m³/g.

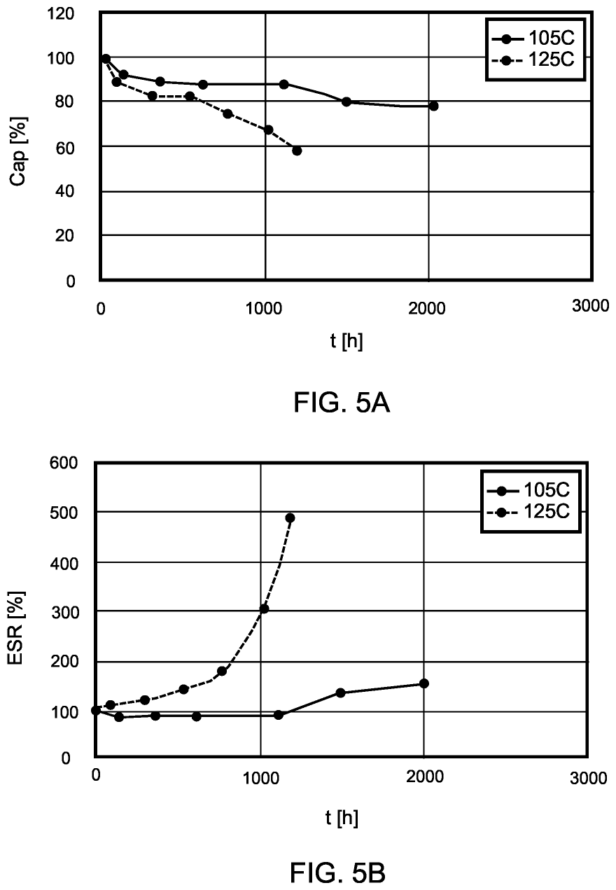

The jellyrolls were then subjected to the same endurance testing as described in Example 1, except that the floated voltage was 2.2 V and that the jellyrolls were tested at two different temperatures, wherein the first test chamber was 105° C. and the second test chamber was 125° C. The results are set forth in FIG. 5A and FIG. 5B.

### EXAMPLE 6

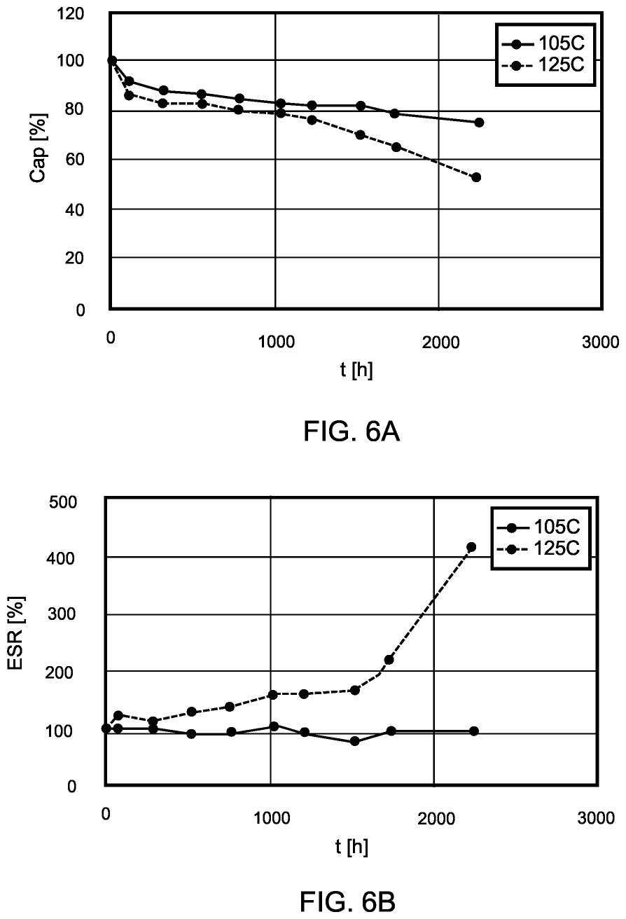

The electrodes were prepared in the same manner as in Example 5, except that the first coating was formed to be 145 μm thick and the second coating was formed to be 175 μm thick. The jellyrolls were configured such that when they were wound, the second coating is unpaired and is positioned on an outer perimeter of the jellyroll configuration. The jellyrolls were then subjected to the same endurance testing as described in Example 5. The results are set forth in FIG. 6A and FIG. 6B.

As demonstrated by FIGS. 5A-5B and FIGS. 6A-6B, utilizing different porosity profiles, even when in combination with the same electrolyte system, results in varying capacitance and ESR retention rates. Additionally, as demonstrated by FIGS. 5A-5B and FIGS. 6A-6B, utilizing an unpaired second electrode that is positioned on the outer perimeter of the jellyroll configuration may result in higher capacitance retention rates and lower ESR gain rates.

These and other modifications and variations of the present invention may be practiced by those of ordinary skill in the art, without departing from the spirit and scope of the present invention. In addition, it should be understood that aspects of the various embodiments may be interchanged both in whole and in part. Furthermore, those of ordinary skill in the art will appreciate that the foregoing description is by way of example only and is not intended to limit the invention so further described in such appended claims.

What is claimed is:

1. An ultracapacitor comprising:
a first electrode that comprises a first current collector electrically coupled to a first carbonaceous coating;
a second electrode that comprises a second current collector electrically coupled to a second carbonaceous coating;
a separator positioned between the first electrode and the second electrode;
an electrolyte system in ionic contact with the first electrode and the second electrode, wherein the electrolyte system comprises a sulfur-containing compound having a boiling point of about 200° C. or greater, a nonaqueous solvent having a boiling point of about 200° C. or less, and an ionic liquid comprising a cationic species and a counterion dissolved in the nonaqueous solvent;
a housing within which the first electrode, the second electrode, the separator, and the electrolyte system are retained; and
wherein the first carbonaceous coating has a first thickness, the second carbonaceous coating has a second thickness, and the ultracapacitor has a ratio of the first thickness to the second thickness of from about 1.0 to about 2.5.

2. The ultracapacitor of claim 1, wherein the ratio of the first thickness of the first carbonaceous coating to the second thickness of the second carbonaceous coating is from about 1.1 to about 2.0, such as from about 1.15 to about 1.3.

3. The ultracapacitor of claim 1, wherein the first carbonaceous coating, the second carbonaceous coating, or both have a thickness of about 250 micrometers or less.

4. The ultracapacitor of claim 1, wherein the first carbonaceous coating has a first plurality of pores with a first total pore volume, the second carbonaceous coating has a second plurality of pores with a second total pore volume, and further wherein the first total pore volume, the second total pore volume, or both, comprise about 50 vol. % or less of pores having a median pore diameter size of about 2 nanometers or less.

5. The ultracapacitor of claim 1, wherein the sulfur-containing compound has a boiling point of about 215° C. to about 325° C.

6. The ultracapacitor of claim 1, wherein the sulfur-containing compound comprises a first sulfur-containing compound and a second-sulfur containing compound.

7. The ultracapacitor of claim 6, wherein the first sulfur-containing compound has a boiling point of about 270° C. to about 300° C. and is present in an amount of from about 30 wt. % to about 50 wt. % based on the weight of the electrolyte system.

8. The ultracapacitor of claim 6, wherein the second sulfur-containing compound has a boiling point of about 220° C. to about 250° C. and is present in an amount of from about 1 wt. % to about 10 wt. % based on the weight of the electrolyte system.

9. The ultracapacitor of claim 6, wherein the first sulfur-containing compound comprises a sulfolane and the second sulfur-containing compound comprises a sulfone.

10. The ultracapacitor of claim 1, wherein the ionic liquid is present in an amount of from about 10 wt. % to about 55 wt. % based on the weight of the electrolyte system.

11. The ultracapacitor of claim 1, wherein the nonaqueous solvent comprises a nitrile compound, wherein the nitrile compound is present in an amount of from about 10 wt. % to about 30 wt. % based on the weight of the electrolyte system.

12. The ultracapacitor of claim 1, wherein the cationic species includes an organoquaternary ammonium compound.

13. The ultracapacitor of claim 12, wherein the organoquaternary ammonium compound has the following structure: 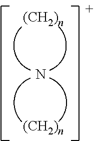
wherein m and n are independently a number from 3 to 7.

14. The ultracapacitor of claim 1, wherein the ionic liquid includes spiro-(1,1′)-bipyrrolidinium tetrafluoroborate, triethylmethyl ammonium tetrafluoroborate, tetraethyl ammonium tetrafluoroborate, 1,1-dimethylpyrrolidinium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, and/or tetraethylammonium hexafluorophosphate, or a combination thereof.

15. The ultracapacitor of claim 1, wherein the ultracapacitor has an operating temperature of about −60° C. to about 150° C.

16. The ultracapacitor of claim 1, wherein the first electrode, the second electrode, and the separator are wound into an electrode assembly having a jellyroll configuration.

17. The ultracapacitor of claim 16, wherein the first electrode is positioned on an outer perimeter of the jellyroll configuration.

18. The ultracapacitor of claim 16, wherein the second electrode is positioned on an outer perimeter of the jellyroll configuration.

19. An electrolyte system, comprising:
a sulfur-containing compound having a boiling point of about 200° C. or greater, wherein the sulfur-containing compound comprises a first sulfur-containing compound and a second sulfur-containing compound;
a nonaqueous solvent having a boiling point of about 200° C. or less;
an ionic liquid comprising a cationic species and a counterion dissolved in the nonaqueous solvent;
wherein the first sulfur-containing compound is present in an amount of from about 30 wt. % to about 50 wt. %, the second sulfur-containing compound is present in an amount of from about 1 wt. % to about 10 wt. %, the ionic liquid is present in an amount of from about 10 wt. % to about 55 wt. %, and the nonaqueous solvent is present in an amount of about 10 wt. % to about 30 wt. % based on the weight of the electrolyte system.

20. The electrolyte system of claim 19, wherein the first sulfur-containing compound comprises a sulfolane and/or a sulfolane derivative.

21. The electrolyte system of claim 19, wherein the first sulfur-containing compound has a boiling point of about 270° C. to about 300° C.

22. The electrolyte system of claim 19, wherein the second sulfur-containing compound comprises a sulfone, such as an alkyl sulfone.

23. The electrolyte system of claim 19, wherein the second sulfur-containing compound comprises dimethyl sulfone, ethyl methyl sulfone, dipropyl sulfone, ethyl propyl sulfone, diethyl sulfone, dibutyl sulfone, propyl methyl sulfone, diisopropyl sulfone, isopropyl methyl sulfone, isopropyl ethyl sulfone, and combinations thereof.

24. The electrolyte system of claim 19, wherein the second sulfur-containing compound has a boiling point of about 220° C. to about 250° C.

25. The electrolyte system of claim 19, wherein the ionic liquid comprises an organoquaternary ammonium compound, organoquaternary phosphonium compound, or a mixture thereof.

26. The electrolyte system of claim 19, wherein the ionic liquid comprises a spiro compound.

27. The electrolyte system of claim 19, wherein the nonaqueous electrolyte comprises a nitrile compound.
